(19) United States
(12) Patent Application Publication
(10) Pub. No.: US 2009/0087662 A1
(43) Pub. Date: Apr. 2, 2009

(54) HOLLOW PARTICLES, METHOD FOR PRODUCING SAME, AND THERMAL TRANSFER IMAGE-RECEIVING SHEET

(75) Inventors: Toshihide YOSHITANI, Kanagawa (JP); Hideyuki SHIRAI, Kanagawa (JP); Takayasu NAGAI, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/238,942

(22) Filed: Sep. 26, 2008

(30) Foreign Application Priority Data
Sep. 27, 2007 (JP) 2007-250658

(51) Int. Cl. B32B 15/02; B32B 5/16

(52) U.S. Cl. 428/407; 264/343

(57) ABSTRACT

A hollow particle having a core/shell structure in which the core contains an acid group and is crosslinked, the surface of the core is covered with an interlayer of an acid group-free, crosslinked resin having a Tg of from −60° C. to 80° C., the surface of the interlayer is covered with an outer layer of an acid group-free, crosslinked resin having a Tg of from 80 to 150° C., and the particle has a hollow structure inside thereof that is produced by ionizing and swelling the acid group of the core by the action of a volatile base.

### BACKGROUND OF THE INVENTION

1. Field of the Invention

The present invention relates to hollow particles capable of forming a coating film excellent in flexibility and heat resistance and having a hollow morphology, and to a method for producing them. Further, the invention relates to using the hollow particles for providing a thermal transfer image-receiving sheet which is excellent in the maximum transfer density and which has few image failures such as density unevenness and pin holes.

2. Description of the Related Art

Heretofore, hollow particles and latex of hollow particles are used in a coating field of water-base coating materials, paper-coating technology, etc. In particular, based on the light scattering phenomenon that is expressed by the hollow morphology of the coating film thereof, hollow particles and others are widely used in producing masking, nontransparent or white organic pigments.

In general, the hollow particles in an already-existing hollow particle latex comprise a hard material having a high glass transition temperature (Tg) for protecting the hollow morphology thereof from heat and stress in a coating film comprising them. Accordingly, the coating film formed of an already-existing hollow particle latex tends to have poor flexibility.

On the other hand, for producing a hollow particle latex, essentially known are a phase separation method, a foaming method, and an osmotic pressure swelling method.

The phase separation method (see JP-A 61-87734) comprises applying a monomer component that contains a crosslinking monomer to seed particles prepared through emulsion polymerization so that the particles may absorb the monomer, thereby producing an aqueous dispersion condition of the swollen seed particles. In this method, when the polymerization is initiated by a water-soluble polymerization initiator, then the polymerization starts from the surface of the swollen seed particles and then a hollow is formed inside each particle owing to phase separation caused by polymerization shrinkage.

According to the method, it is difficult to soften the particles because of the reason that a large amount of a crosslinking agent is needed for producing a plenty of hollows.

The foaming method (see JP-A 4-178442) is for producing thermal-expansive microcapsules by dispersing an oily phase comprising a thermoplastic resin monomer, a low-boiling-point organic solvent and a polymerization initiator, in an aqueous phase containing a dispersant, and polymerizing it. These are foamed at a temperature not lower than the softening point of the polymer surrounding them, thereby forming a hollow inside them. In the method, the expansion coefficient of the particles in forming a hollow therein is extremely large and the wall of the resulting hollow particles is thereby thinned; and according to the method, therefore, the coating film comprising the hollow particles could hardly keep the hollow morphology of the particles. In addition, since the particle size reaches dozens of microns, the coating film could hardly be smooth, and the method has another problem in that, when the coating film is smoothed, then calendering treatment is indispensable for them.

The osmotic pressure swelling method is method for hollow formation by adding a volatile base to an acid group-having core followed by swelling the core by osmotic pressure; and this is known as a most popular method for formation of hollow particles. Its detailed technology is described in Hollow Latex Particles: Synthesis and Applications, MCDONALD C. J., DEVON M. J. (Dow Chemical Co., MI, USA), Adv. Colloid Interface Sci., 99, 181-213 (2002); and the reference discloses various techniques of forming hollow particles.

In general, for softening the coating film comprising hollow particles, it is effective to lower Tg of the resin that constitutes the shell of the particles. However, this is problematic in that the particles may be often broken during swelling under osmotic pressure and that the resulting hollow particles may be often deformed by stress. Naturally, in addition, the heat resistance of the particles is inevitably lowered.

Apart from the above-mentioned methods, another method has been proposed (see Polymer. Mater. Sci. Eng., 64, 345-346 (1991), JP-A 10-110018 and WO98/39372) of making the shell of a hollow particle have a two-layered structure and planning the structure in such a manner that the inner layer is formed of a flexible resin and the outer layer is formed of a heat-resistant resin.

In Polymer. Mater. Sci. Eng., 64, 345-346 (1991), hollow particles are formed according to the following process. Concretely, (1) a carboxylic acid-having core comprising methyl methacrylate, methacrylic acid and ethylene glycol dimethacrylate is formed, (2) an interlayer comprising methyl methacrylate, butyl methacrylate and methacrylic acid is formed, (3) the outermost layer is covered with a hard shell comprising styrene and divinyl benzene, (4) a volatile base is added to the particles so as to swell them by osmotic pressure, and (5) the outermost layer is covered with a hard resin comprising styrene and divinylbenzene, thereby forming hollow particles.

In JP-A 10-110018, hollow particles are formed according to the following process. Concretely, (1) a core comprising from 35 to 60% by mass of an acid group-having monomer and from 40 to 65% by mass of a monomer copolymerizable with the former monomer is formed, (2) an interlayer composed of a copolymer having a glass transition temperature of from 25° C. to 85° C. is formed by polymerizing a monomer or a monomer mixture comprising at least one, acid group-free monomer except aromatic vinyl monomers, (3) an outermost layer comprising an aromatic vinyl compound as the main ingredient thereof is formed, (4) a volatile base is added to the particles so as to swell them by osmotic pressure, thereby forming hollow particles.

However, in these methods, the fluidity of the soft intermediate layer is high and therefore the polymer penetrates into the interlayer during the formation of the outermost layer, whereby the boundary between the layers becomes indefinite; and these methods are problematic in that the formed particles could not have sufficient heat resistance.

On the other hand, in WO98/39372, hollow particles are formed according to the following process. Concretely, (1) a carboxylic acid-having core that comprises methyl methacrylate, unsaturated carboxylic acid, crosslinking agent and other aromatic vinyl compound is formed, (2) an interlayer composed of a copolymer that comprises methyl methacrylate, acrylate, crosslinking agent, unsaturated carboxylic acid and other aromatic vinyl compound and having Tg of not higher than 80° C. is formed, (3) a volatile base is added to the particles so as to swell them by osmotic pressure, (4) and an outermost layer is formed of a shell that comprises aromatic vinyl compound, acrylonitrile and/or methyl methacrylate and crosslinking agent, thereby forming hollow particles.

However, in this method, the flexible interlayer contains a carboxylic acid, and therefore after addition of the volatile base to the particles, the carboxylic acid density in the surface increases. Even though the surface is desired to be covered with an oleophilic outermost layer in that condition, the coating efficiency is insufficient and there occurs a problem in that the particles could not have desired heat resistance.

On the other hand, various thermal recording methods are heretofore known for thermal transfer recording materials. Above all, a dye-diffusion transfer recording system is specifically noted as a process capable of producing color hard copies most nearest to the quality of silver salt photographs. Moreover, as compared with silver salt photographs, the system has various advantages in that it is a dry process, visible images can be directly formed from digital data, and duplication is easy.

In the dye-diffusion transfer recording system, a dye-containing thermal transfer sheet and a thermal transfer image-receiving sheet are put one upon another, and then the thermal transfer sheet is heated by a thermal head from which the heat generation is controlled by an electric signal whereby the dye in the thermal transfer sheet is transferred onto the thermal transfer image-receiving sheet to thereby record image informations on the latter. In the system, three colors of cyan, magenta and yellow, or four colors of these three and black are recorded one upon another to thereby form a transferred color image having a continuous color density gradation.

Ordinary paper may be used as the support for the thermal transfer image-receiving sheet in this system, and the sheet can be produced at a low cost. The image-receiving sheet comprising paper as the support thereof generally has a cushioning layer, for example, a foam layer comprising a resin and a foaming agent, between the support and the image-receiving layer for supplementing the cushion property of the support, thereby imparting a cushioning property to the support so as to enhance the airtight contact between the thermal transfer image-receiving sheet and the thermal transfer sheet attached thereto. In addition, an interlayer may be further provided between the foam layer and the receiving layer to thereby prevent the foam layer from being crushed by heat given thereto during printing. However, in the conventional image-receiving sheet, the interlayer is formed of an organic solvent-based resin coating liquid; and in this, therefore, the coating liquid crushes the foams and hollows of the foam layer, and the sheet could not have a desired cushion property, therefore having problems in that the transferred image may have pin hopes and density unevenness, the heat resistance of the foam layer may be lowered and the quantity of heat necessary for dye transfer may diffuse toward the back of the image-receiving sheet thereby lowering the printing sensitivity of the sheet.

Different from the above, another proposal has been made for forming the interlayer between the foam layer and the receiving layer by the use of a water-base coating liquid so that the receiving layer could take the delicate surface roughness of the foam layer directly from the foam layer (see JP-A 8-25813); however, in the method, the foam layer is formed on the support, then this is heated and dried and thereafter the receiving layer is formed, and accordingly, the surface of the receiving layer is roughened therefore causing problems in that there may occur many image failures and the sensitivity is insufficient and, in addition, the production cost is high. Further proposed is forming an interlayer that hollow particles and an organic solvent-resistant polymer as the main ingredients thereof, between a support and a receiving layer; or incorporating hollow capsules into a resin layer including a receiving layer (see JP-A 4-178442 and JP-A 11-321128). Also in this method, however, the interlayer and the resin layer are formed, then heated and dried, and thereafter the receiving layer is formed thereon, and as a result, the surface of the receiving layer is roughened therefore causing problems in that there may occur many image failures and the sensitivity is insufficient and the production cost is high.

For solving these problems, proposed is simultaneous formation of a hollow particle latex-containing interlayer and a receiving layer according to a double-coating method (see JP-A 2007-55254). This has made it possible to produce a thermal transfer image-receiving sheet at a low cost and has made it possible to solve the problem of surface roughness of the sheet. However, the coating film is still poorly flexible, and the sheet could not completely solve the problem of image failures.

### SUMMARY OF THE INVENTION

The present invention is to provide hollow particles capable of forming a coating film that has excellent flexibility and heat resistance and has a hollow morphology, in particular to provide a latex of such hollow particles and a method for producing it. In addition, the invention is also to provide a thermal transfer image-receiving sheet that is free from image failures such as density unevenness and pin holes and has an excellent maximum transfer density, by the use of the hollow particles.

The present inventors have assiduously studied and, as a result, have found out hollow particles having a layer constitution of specific materials and a method for producing it, and have solved the above problems.

The means for solving the problems are mentioned below.

<1> A hollow particle having a core/shell structure in which the core contains an acid group and is crosslinked, the surface of the core is covered with an interlayer of an acid group-free, crosslinked resin having a glass transition temperature (Tg) of from −60° C. to 80° C., the surface of the interlayer is covered with an outer layer of an acid group-free, crosslinked resin having a glass transition temperature (Tg) of from 80 to 150° C., and the particle has a hollow structure inside thereof that is produced by ionizing and swelling the acid group of the core by the action of a volatile base.

<2> The hollow particle of <1>, wherein the ratio by mass of the core to the shell (ratio by mass of core/shell) falls within a range of from 1/99 to 50/50, and the ratio by mass of the interlayer to the outer layer in the shell (ratio by mass of interlayer/outer layer) falls within a range of from 60/40 to 90/10.

<3> The hollow particle of <1> or <2>, wherein the core containing an acid group is a copolymer and contains a repetitive unit of the following formula [1]:

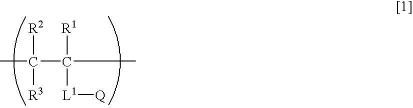

[in formula [1], R¹, R² and R³ each independently represent a hydrogen atom or a substituent; L¹ represents a group selected from the following linking groups, or a divalent linking group formed by combining two or more of the linking group; Q represents a carboxyl group (—COOH), a sulfo group (—SO₃H), or a phosphoryl group (—OPO₃H);

### (Linking Group)

single bond, —O—, —CO—, —NR⁴—, —S—, —SO₂—, —P(═O)(OR⁵)—, alkylene group, arylene group (R⁴ represents a hydrogen atom, an alkyl group, a cycloalkyl group, an aryl group or an aralkyl group; R⁵ represents an alkyl group, a cycloalkyl group, an aryl group or an aralkyl group)].

<4> The hollow particle of any one of <1> to <3>, wherein the core containing an acid group is a copolymer with methacrylic acid or acrylic acid.

<5> The hollow particle of any one of <1> to <4>, wherein the interlayer is a copolymer of a monomer selected from aromatic vinyl compounds and (meth)acrylates.

<6> A method for producing a hollow particle having a core/shell structure in which the core contains an acid group and is crosslinked, the surface of the core is covered with an interlayer of an acid group-free, crosslinked resin having a glass transition temperature (Tg) of from −60° C. to 80° C., and the surface of the interlayer is covered with an outer layer of an acid group-free, crosslinked resin having a glass transition temperature (Tg) of from 80 to 150° C.;

the method comprising ionizing the acid group of the core through contact with a volatile base and then swelling it under osmotic pressure to thereby form a hollow structure.

<7> The method for producing a hollow particle of <6>, wherein the ratio by mass of the core to the shell (ratio by mass of core/shell) falls within a range of from 1/99 to 50/50, and the ratio by mass of the interlayer to the outer layer in the shell (ratio by mass of interlayer/outer layer) falls within a range of from 60/40 to 90/10.

<8> The method for producing a hollow particle of <6> or <7>, wherein the core containing an acid group is a copolymer and contains a repetitive unit of the following formula [1]:

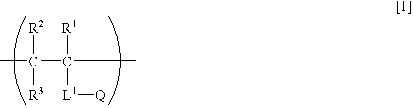

[in formula [1], R¹, R² and R³ each independently represent a hydrogen atom or a substituent; L¹ represents a group selected from the following linking groups, or a divalent linking group formed by combining two or more of the linking groups; Q represents a carboxyl group (—COOH), a sulfo group (—SO₃H), or a phosphoryl group (—OPO₃H);

### (Linking Group)

single bond, —O—, —CO—, —NR⁴—, —S—, —SO₂—, —P(═O) (OR⁵)—, alkylene group, arylene group (R⁴ represents a hydrogen atom, an alkyl group, a cycloalkyl group, an aryl group or an aralkyl group; R⁵ represents an alkyl group, a cycloalkyl group, an aryl group or an aralkyl group)].

<9> The method for producing a hollow particle of any one of <6> to <8>, wherein the core containing an acid group is a copolymer with methacrylic acid or acrylic acid.

<10> The method for producing a hollow particle of any one of <6> to <9>, wherein the interlayer is a copolymer of a monomer selected from aromatic vinyl compounds and (meth)acrylates.

<11> The method for producing a hollow particle of any one of <6> to <10>, wherein the particle is produced through seed emulsion polymerization.

<12> The method for producing a hollow particle of any one of <6> to <11>, which comprises contacting the particle having a structure of such that the surface of the core that contains an acid group and is crosslinked is covered with an interlayer of an acid group-free, crosslinked resin having a glass transition temperature (Tg) of from −60° C. to 80° C. and the surface of the interlayer is covered with an outer layer of an acid group-free, crosslinked resin having a glass transition temperature (Tg) of from 80 to 150° C., with a volatile base to thereby ionize the acid group of the core and swelling it under osmotic pressure to form a hollow structure.

<13> A hollow particle produced by the method of any one of <6> to <12>.

<14> A latex of hollow particles of any one of <1> to <5> or <13>.

<15> A film containing hollow particles of any one of <1> to <5> or <13>.

<16> A thermal transfer image-receiving sheet containing an interlayer and a receiving layer formed in order on a support, wherein the interlayer contains hollow particles of any one of <1> to <5> or <13>.

A coating composition comprising hollow particles of the invention, especially a latex of hollow particles may form a coating film excellent in flexibility and heat resistance and having a hollow morphology, and the coating composition is especially favorable for the interlayer of a thermal transfer image-receiving sheet.

### BEST MODE FOR CARRYING OUT THE INVENTION

The hollow particle of the invention, the method for producing it and the thermal transfer image-receiving sheet comprising it are described in detail hereinunder. The description of the constitutive elements of the invention given hereinunder is for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof.

First described are the hollow particles of the invention in detail.

### <<Hollow Particles>>

### (Basic Structure)

The hollow particle of the invention is a core/shell particle that comprises a core having an acid group and a shell substantially not having an acid group, and is a hollow particle produced by ionizing the acid group of the core by addition of a volatile base thereto followed by swelling it under osmotic pressure to thereby form a hollow structure.

### (Acid Group-Having Core)

The acid group-having core is not specifically defined in point of its details so far as at least a part of the molecules constituting the core have an acid group. The acid group as referred to herein means a group that dissolves in water to be acidic (having a pH of less than 7), and includes a carboxyl group (—COOH), a sulfo group (—SO₃H), a phosphoryl group (—OPO₃H), —CSOH, —COSH, —CSSH, —SO₂H, and —PO₃H. Preferred are a carboxyl group (—COOH), a sulfo group (—SO₃H), and a phosphoryl group (—OPO₃H).

On the other hand, the polymer to form the acid group-having core is preferably a polymer obtained from monomers mentioned below, including polyvinyl polymers and polyesters polymers. In the invention, preferred are the polymers that contains a repetitive unit of the following formula [1]:

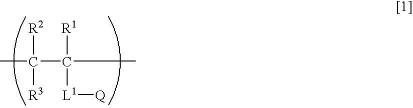

In formula [1], R¹, R² and R³ each independently represent a hydrogen atom or a substituent; L¹ represents a group selected from the following linking groups, or a divalent linking group formed by combining two or more of the linking groups; Q represents a carboxyl group (—COOH), a sulfo group (—SO₃H), or a phosphoryl group (—OPO₃H):

### (Linking Group)

Single bond, —O—, —CO—, —NR⁴—, —S—, —SO₂—, —P(═O) (OR⁵)—, alkylene group, arylene group (R⁴ represents a hydrogen atom, an alkyl group, a cycloalkyl group, an aryl group or an aralkyl group; R⁵ represents an alkyl group, a cycloalkyl group, an aryl group or an aralkyl group).

Q is especially preferably a carboxyl group.

The substituent for R¹, R² and R³ may be any one not specifically defined. Preferred examples of the substituent for R¹, R² and R³ include, for example, an alkyl group, a cycloalkyl group, a halogen atom, (e.g., fluorine atom, chlorine atom, bromine atom, iodine atom), and a group of the above-mentioned -L¹-Q. Specific examples of the alkyl group include a methyl group, an ethyl group, an n-propyl group, an n-butyl group, and a sec-butyl group. The alkyl group may have a substituent, and the substituent includes a halogen atom, an aryl group, a heterocyclic group, an alkoxyl group, an aryloxy group, an alkylthio group, an arylthio group, an acyl group, a hydroxyl group, an acyloxy group, an amino group, an alkoxycarbonyl group, an acylamino group, an oxycarbonyl group, a carbamoyl group, a sulfonyl group, a sulfamoyl group, a sulfonamide group, a sulforyl group, and a carboxyl group.

Preferably, R¹, R² and R³ each are a hydrogen atom, an alkyl group having from 1 to 6 carbon atoms, a chlorine atom, or a group of -L¹-Q, more preferably a hydrogen atom or an alkyl group having from 1 to 4 carbon atoms, most preferably a hydrogen atom or an alkyl group having 1 or 2 carbon atoms. The number of the carbon atoms constituting the alkyl group does not include the carbon atoms of the substituent. In the invention, the same shall apply to the number of the carbon atoms of the other groups.

Preferably, L¹ includes a single bond, —O—, —CO—, —NR⁴—, —S—, —SO₂—, an alkylene group or an arylene group, more preferably —O—, —CO—, —NR⁴—, an alkylene group or an arylene group.

When L¹ includes an alkylene group, the number of the carbon atoms of the alkylene group is preferably from 1 to 10, more preferably from 1 to 8, even more preferably from 1 to 6. Preferred examples of the alkylene group include a methylene group, an ethylene group, a trimethylene group, a tetramethylene group, and a hexamethylene group.

When L¹ includes an arylene group, the number of the carbon atoms of the arylene group is preferably from 6 to 24, more preferably from 6 to 18, even more preferably from 6 to 12. The arylene group includes a phenylene group and a naphthylene group; and an optionally-substituted phenylene group is preferred.

In case where L¹ includes a divalent linking group of a combination of an alkylene group and an arylene group, or that is, an aralkylene group, the number of the carbon atoms of the aralkylene group is preferably from 7 to 34, more preferably from 7 to 26, even more preferably from 7 to 16. Preferred examples of the aralkylene group include a phenylenemethylene group, a phenyleneethylene group, and a methylenephenylene group.

The groups of L¹ may have a substituent; and the substituent includes the substituents of the above-mentioned R¹, R² and R³, and the substituents by which the substituents of R¹, R² and R³ are substituted.

Specific structures of L¹ are mentioned below, to which, however, L¹ employable in the invention should not be limited.

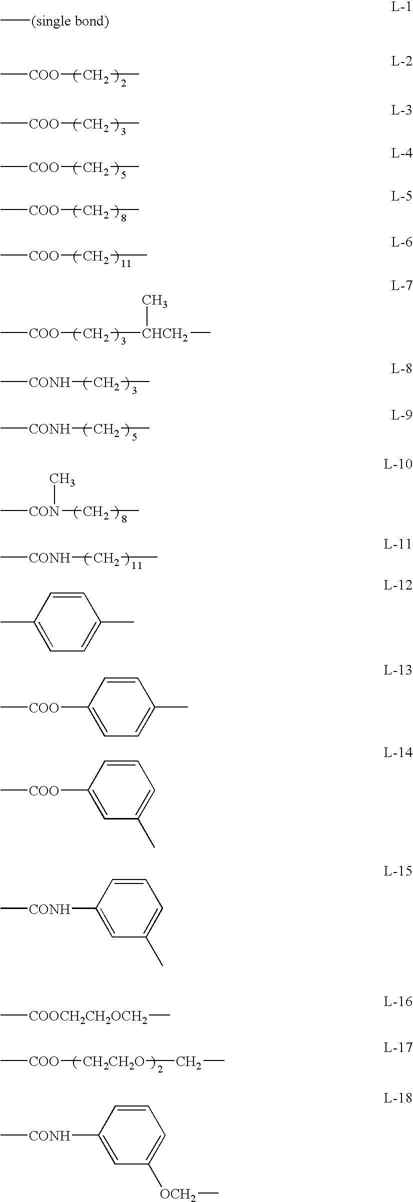

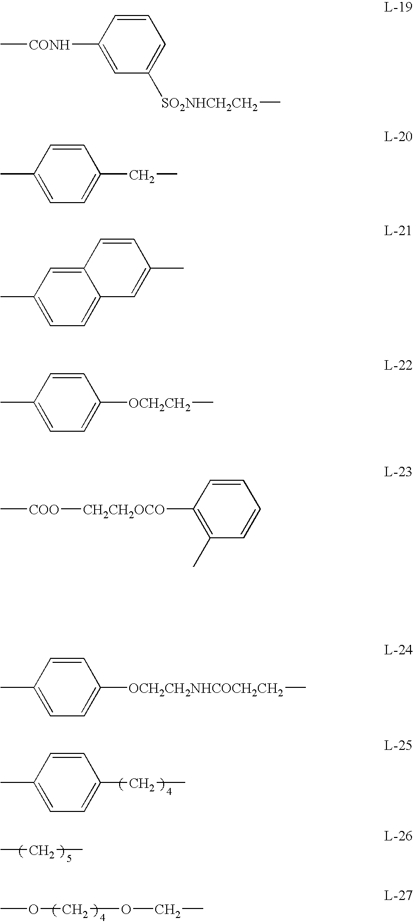

The repetitive unit of formula [1] to be in the polymer may be one type alone; or two or more different types of the units may be in the polymer as combined.

Preferably, the core is a copolymer of a monomer having an acid group and a monomer not having an acid group.

The repetitive unit of formula [1] may be formed by copolymerization of an acid group-having monomer.

Preferred examples of the acid group-having monomer include methacrylic acid, acrylic acid, crotonic acid, itaconic acid, fumaric acid, and maleic acid. More preferred are methacrylic acid and acrylic acid.

In the core, the proportion of the acid group-having monomer may be from 5 to 50% by mass, preferably from 10 to 40% by mass, more preferably from 15 to 30% by mass. When the acid group content is too low, the swelling under osmotic pressure may be insufficient; but when the acid group content is too high, then the producibility may be poor.

The acid group-free monomer for use in producing the copolymer is not specifically defined. Monomers of the following groups (a) to (i) are favorably used, which are polymerizable in ordinary radical polymerization or ionic polymerization. These monomers may be combined in any desired manner and may be used in producing the polymer latex.

—Monomer Groups (a) to (i)—

### (a) Conjugated Dienes:

1,3-Pentadiene, isoprene, 1-phenyl-1,3-butadiene, 1-α-naphthyl-1,3-butadiene, 1-β-naphthyl-1,3-butadiene, cyclopentadiene, etc.

### (b) Olefins:

Ethylene, propylene, vinyl chloride, vinylidene chloride, 6-hydroxy-1-hexene, 4-pentenoic acid, methyl 8-nonenoate, vinylsulfonyl acid, trimethylvinylsilane, trimethoxyvinylsilane, 1,4-divinylcyclohexane, 1,2,5-trivinylcyclohexane, etc.

### (c) α,β-Unsaturated Carboxylates:

Alkyl acrylates (e.g., methyl acrylate, ethyl acrylate, butyl acrylate, cyclohexyl acrylate, 2-ethylhexyl acrylate, dodecyl acrylate), substituted alkyl acrylates (e.g., benzyl acrylate, 2-cyanoethyl acrylate), alkyl methacrylates (e.g., methyl methacrylate, butyl methacrylate, 2-ethylhexyl methacrylate, dodecyl methacrylate), substituted alkyl methacrylates (e.g., 2-hydroxyethyl methacrylate, glycidyl methacrylate, glycerin monomethacrylate, 2-acetoxyethyl methacrylate, tetrahydrofurfuryl methacrylate, 2-methoxyethyl methacrylate, polypropylene glycol monomethacrylate (number of mols of added polyoxypropylene=2 to 100), 3-N,N-dimethylaminopropyl methacrylate, 2-carboxyethyl methacrylate, 3-sulfopropyl methacrylate, 4-oxysulfobutyl methacrylate, 3-trimethoxysilylpropyl methacrylate, allyl methacrylate, 2-isocyanatoethyl methacrylate), unsaturated dicarboxylic acid derivatives (e.g., monobutyl maleate, dimethyl maleate, monomethyl itaconate, dibutyl itaconate), polyfunctional esters (e.g., ethylene glycol diacrylate, ethylene glycol dimethacrylate, 1,4-cyclohexane diacrylate, pentaerythritol tetramethacrylate, pentaerythritol triacrylate, trimethylolpropane triacrylate, trimethylolethane triacrylate, dipentaerythritol pentamethacrylate, pentaerythritol hexaacrylate, 1,2,4-cyclohexane tetramethacrylate), etc.
(d) α,β-unsaturated carboxylic amides:
Acrylamide, methacrylamide, N-methylacrylamide, N,N-dimethylacrylamide, N-methyl-N-hydroxyethylmethacrylamide, N-tert-butylacrylamide, N-tert-octylmethacrylamide, N-cyclohexylacrylamide, N-phenylacrylamide, N-(2-acetacetoxyethyl)acrylamide, N-acryloylmorpholine, diacetonacrylamide, itaconic diamide, N-methylmaleimide, 2-acrylamido-methylpropanesulfonic acid, methylenebisacrylamide, dimethacryloylpiperazine, etc.
(e) Unsaturated nitriles:
Acrylonitrile, methacrylonitrile, etc.
(f) Styrene and its derivatives:
Styrene, vinyltoluene, p-tert-butylstyrene, vinylbenzoic acid, methyl vinylbenzoate, α-methylstyrene, vinylnaphthalene, p-hydroxymethylstyrene, sodium p-styrenesulfonate, potassium p-styrenesulfinate, p-aminomethylstyrene, 1,4-divinylbenzene, etc.
(g) Vinyl ethers:
Methyl vinyl ether, butyl vinyl ether, methoxyethyl vinyl ether, etc.
(h) Vinyl esters:
Vinyl acetate, vinyl propionate, vinyl benzoate, etc.
(i) Other polymerizing monomers:
N-vinylimidazole, 4-vinylpyridine, N-vinylpyrrolidone, 2-vinyloxazoline, 2-isopropenyloxazoline, divinylsulfone, etc.

One or more of these monomers may be used either singly or as combined.

The acid group-having core that constitutes the hollow particle of the invention is crosslinked. The crosslinking structure may be formed through polymerization in the presence of a crosslinking agent in core formation.

The crosslinking agent to be used in core formation through polymerization is one having at least two ethylenic unsaturated groups in one molecule. Examples of the crosslinking agent having at least two ethylenic unsaturated groups include esters of polyalcohol and (meth)acrylic acid (e.g., ethylene glycol di(meth)acrylate, diethylene glycol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate, polyester polyacrylate), vinyl benzene and its derivatives (e.g., 1,4-divinylbenzene, 2-acryloylethyl 4-vinylbenzoate, 1,4-divinylcyclohexanone), vinylsulfones (e.g., divinylsulfone), acrylamides (e.g., methylenebisacrylamide), and methacrylamides. Two or more of these crosslinking agents may be used as combined. In this description, “(meth)acrylate” means “acrylate or methacrylate”.

### (Shell)

The shell substantially envelops the core, and it may be laminated on the core through polymerization of an acid group-free monomer in the presence of the core. In the invention, the acid group-having core is enveloped with the acid group-free shell in such a manner that the shell comprises an interlayer of a crosslinked resin having a glass transition temperature (Tg) of from −60° C. to 80° C. and an outer layer of a resin having a glass transition temperature (Tg) of from 80 to 150° C. as laminated in that order from the side of the core. The interlayer substantially envelops the core, and it may be laminated on the surface of the core through polymerization of an acid group-free monomer in the presence of the core. The outer layer substantially envelops the interlayer, and it may be laminated on the surface of the interlayer through polymerization of an acid group-free monomer in the presence of the interlayer-coated core particle. In this, the interlayer is crosslinked and therefore the polymer of the interlayer is prevented from penetrating into the outer layer during the outer layer formation, whereby the boundary between the interlayer and the outer layer is prevented from being indefinite, and therefore the formed particle may have sufficient heat resistance. Preferably, the interlayer is a single layer, but may be have a multilayer structure of two or more plural layers. Also preferably, the outer layer is a single layer, but may have a multilayer structure of two or more plural layers.

For the acid group-free monomer to be used in producing the polymer for constituting the interlayer and the outer layer, preferred are the above-mentioned monomer groups (a) to (i). However, the monomer for forming the polymer for the interlayer is so selected that its polymer may have a glass transition temperature (Tg) of from −60 to 80° C. The monomer for forming the polymer for the outer layer is so selected that its polymer may have a glass transition temperature (Tg) of from 80° C. to 150° C.

The glass transition temperature (Tg) may be computed and estimated according to the following formula:

1/Tg=Σ(Xi/Tgi)

In this, the polymer is considered to be formed through copolymerization of n's monomer ingredients of from i=1 to i=n. Xi means the mass fraction of the i'th monomer (ΣXi=1); Tgi means the glass transition temperature (absolute temperature) of a homopolymer of the i'th monomer. Σ means a sum of the data of from i=1 to i=n. The data of the glass transition temperature of the homopolymer of each monomer (Tgi) are taken from the description in Polymer Handbook (3rd Edition) written by J. Brandrup, and E. H. Immergut, Wiley-Interscience (1989).

The total mass ratio of core to shell, as core/shell, is preferably from 1/99 to 50/50, more preferably from 3/97 to 35/65, even more preferably from 5/95 to 20/80. The mass ratio of the outer layer to the whole shell is preferably from 1 to 50% by mass, more preferably from 5 to 30% by mass, even more preferably from 10 to 20% by mass. When the proportion of the interlayer to the outer layer is too large, then the heat resistance of the outer layer may be poor; but on the contrary, when the proportion of the outer layer to the interlayer is too large, then the particle could not be flexible.

### (Polymer Latex)

The hollow particles of the invention are preferably in the form of a polymer latex. The polymer latex is a dispersion of a water-insoluble hydrophobic polymer dispersed in a water-soluble dispersion medium as fine particles therein.

Polymer latex is described in “Synthetic Resin emulsion” edited by Taira Okuda & Hiroshi Inagaki, published by the Polymer Publishing Association (1978); “Application of Synthetic Latex” edited by Takaaki Sugimura, Yasuo Kataoka, Soichi Suzuki & Keiji Kasahara, published by the Polymer Publishing Association (1993); “Chemistry of Synthetic Latex” edited by Soichi Muroi, published by the Polymer Publishing Association (1970); “Development and Application of Water-Base Coating Materials” edited by Yoshiaki Niyosawa, published by CMC Publishing (2004); and JP-A 64-538.

For producing the core/shell latex in the invention, employable is emulsion, polymerization, soap-free polymerization, seed emulsion polymerization or the like; and seed emulsion polymerization is especially preferred. Regarding the core/shell latex production by seed emulsion polymerization, for example, referred to are the methods described in ACS Symposium Series 492 (Polymer Latexes), pp. 234-254 (1992); RD 30803 (September, 1989); “Polymer Memoirs”, Vol. 31, No. 9, pp. 576-586 (1974); ibid., Vol. 33, No. 10, pp. 575-583 (1976); ibid., Vol. 33, No. 11, pp. 663-672 (1976); ibid., Vol. 36, No. 7, pp. 459-464 (1979). Regarding the general operation of emulsion polymerization, referred to is Soichi Muroi's Chemistry of Polymer Latex (by the Polymer Publishing Association).

Preferred examples of the surfactant to be used in producing the core/shell latex in the invention are anionic surfactants mentioned below, to which, however, the surfactant usable in the invention should not be limited.

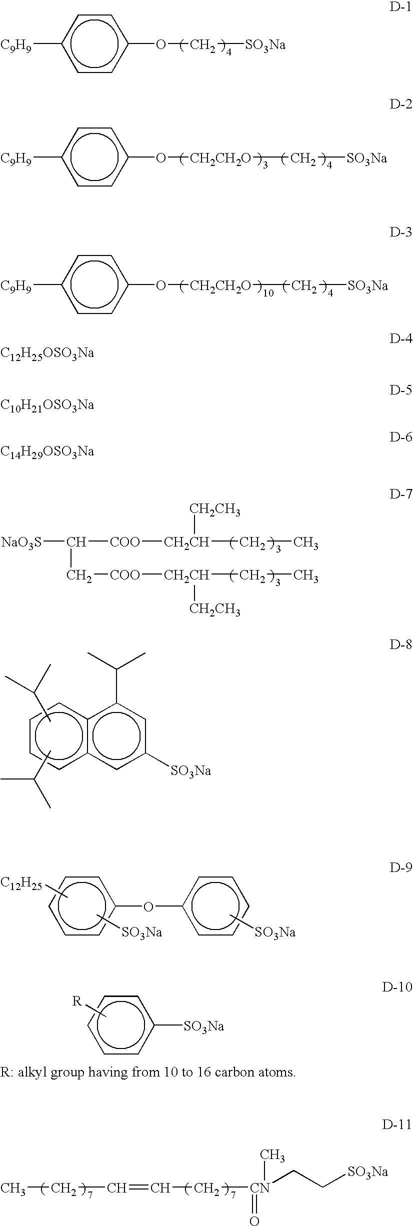

### (Formation of Hollow Structure)

The hollow structure of the hollow particle of the invention is formed by the action of a volatile base, by which the acid group of the core is ionized and swollen.

In the invention, it is desirable that, after the core/shell (interlayer/outer layer) latex formation, a volatile base is added thereto for osmotic pressure swelling to thereby form a hollow structure. In other words, the method of previously completing the shell having the outermost layer followed by adding a volatile base thereto for osmotic pressure swelling is preferred to the method comprising adding a volatile base for osmotic pressure swelling followed by forming the outermost layer of the shell. For example, the particle comprising a core laminated with an interlayer may be swollen under osmotic pressure, and finally an outer layer may be laminated thereon; however, in case where a particle having a flexible shell is swollen, the particle may be broken or deformed, and in case where an outer layer polymer is laminated on the particle after swollen, there may occur a problem in that the particles may aggregate together.

The volatile base to be used herein is meant to indicate one that is evaporated away and removed along with the dispersion medium in the subsequent step of drying the coating liquid layer; and for example, it includes ammonia, triethylamine, etc. Above all, ammonia is preferred. In case where ammonia is used, it is preferably applied to the particles as an aqueous ammonia. The concentration of the aqueous ammonia may be generally from 0.5 to 40%, preferably from 1 to 30%, more preferably from 2 to 20%.

The amount of the volatile base to be added may be suitably determined depending on the type of the shell polymer and on the amount of the acid group in the core. The amount is preferably from 1 to 20 equivalents to the acid group in the core, more preferably from 3 to 10 equivalents.

The temperature in osmotic pressure swelling may be generally from 60 to 100° C., preferably from 70 to 95° C., more preferably from 80 to 90° C. The time for osmotic pressure swelling may be generally from 30 to 180 minutes, preferably from 45 to 120 minutes, more preferably from 60 to 80 minutes.

### <<Film>>

The hollow particles of the invention may be used as various forms. For example, a film containing the hollow particles may be formed and used as such. The film as referred to herein includes not only one formed on a material such as support but also one that is handled independently as a film. The film may be formed by applying a hollow particle latex of the invention onto a base and drying it thereon.

The film formed of the hollow particle latex of the invention has good heat resistance. The heat resistance may be defined by “minimum film formation temperature (MFT)”. The minimum film formation temperature (MFT) given in this description is a value measured by the use of a film formation temperature meter (Yoshimitsu Machinery's MFT-1). When the temperature gradation on an aluminium sample plate has reached equilibrium, a polymer latex is cast to form a thin film thereon and dried, and then the coating film on the sample plate is observed. Within a temperature range not lower than the minimum film formation temperature, a transparent continuous film is formed; but within a temperature range lower than the minimum film formation temperature, the coating is white powder. The boundary temperature is the minimum film formation temperature.

The film formed of the hollow particle latex of the invention is highly flexible. The flexibility may be defined by “dynamic hardness” described below. The dynamic hardness shown in this description is a value measured with an ultra-micro hardness tester (Shimadzu Seisakusho's trade name, DUH-201H).

### <<Thermal Transfer Image-Receiving Sheet>>

### (Basic Structure)

The thermal transfer image-receiving sheet of the invention is described in detail hereinunder.

The thermal transfer image-receiving sheet of the invention (this may be referred to as “image-receiving sheet of the invention”) has at least one receiving layer (dye-receiving layer) on a support, and has at least one, hollow particles-containing heat-insulating layer (porous layer) between the support and the receiving layer. In addition, interlayers such as a white background controlling layer, a charge controlling layer, an adhesive layer, a primer layer and an undercoat layer may be formed between the support and the receiving layer. A lubricant layer may be formed as the outermost layer on the surface of the image-receiving sheet that is put on a thermal transfer sheet.

In the invention, preferably, at least one receiving layer and at least one heat-insulating layer are formed by water-base coating. For formation of each layer, employable is an ordinary method of roll coating, bar coating, gravure coating, gravure reverse coating, die coating, slide coating, curtain coating or the like. The receiving layer, the heat-insulating layer and other layers may be formed separately, or some of them may be combined in any desired manner and may be formed in a mode of multi-layer coating. More preferably, the layers to be on one and the same surface are formed in a mode of simultaneous multilayer coating capable of forming plural layers at the same time, such as slide coating or curtain coating.

Preferably, a curl controlling layer, a writable layer, and a charge controlling layer are formed on the back of the support. The layers on the back of the support may be formed by an ordinary method of roll coating, bar coating, gravure coating, gravure reverse coating or the like.

### (Receiving Layer)

The receiving layer plays a role of receiving the dye transferred from the thermal transfer sheet attached thereto, and keeping the formed image. The image-receiving sheet of the invention has at least one receiving layer at least having a thermoplastic receiving polymer capable of receiving a dye.

Preferred examples of the thermoplastic resin include halogenopolymers such as polyvinyl chloride and polyvinylidene chloride; vinylic resins such as polyvinyl acetate, ethylene/vinyl acetate copolymer, vinyl chloride/vinyl acetate copolymer, vinyl chloride/acrylate copolymer, vinyl chloride/methacrylate copolymer, polyacryl ester, polystyrene and polystyreneacryl; acetal resins such as polyvinyl formal, polyvinyl butyral and polyvinyl acetal; polyester resins such as polyethylene terephthalate and polybutylene terephthalate; polycarbonate resins; cellulose resins as in JP-A 4-296595 and 2002-264543; cellulose resins such as cellulose acetate butyrate (CAB551-0.2, CAB321-0.1, both trade names by Eastman Chemical); polyolefin resins such as polypropylene; polyamide resins such as urea resin, melamine resin and benzoguanamine resin. These resins may be blended in any desired manner within a range within which they are miscible. JP-A 57-169370, 57-207250 and 60-25793 also disclose resins for receiving layer formation.

Of the above-mentioned polymers, preferred for use in the invention are polycarbonates, polyesters, polyurethanes, polyvinyl chloride and its copolymers, styrene/acrylonitrile copolymers, polycaprolactones, and their mixtures; and more preferred are polyesters, polyvinyl chloride and its copolymers, and their mixtures.

Preferably, the receiving polymer is dispersed in a water-soluble dispersion medium as a polymer latex therein. Further, the receiving layer preferably contains a water-soluble polymer in addition to the polymer latex.

### <Polymer Latex>

In the polymer latex, the polymer may be any of linear polymer or branched polymer or crosslinked polymer, and it may also be any of homopolymer formed through polymerization of a single polymer or copolymer formed through polymerization of two or more different monomers. The copolymer may be a random copolymer or a block copolymer. The number-average molecular weight of the polymer is preferably from 5000 to 1000000, preferably from 10000 to 500000. The polymer having a too small molecular weight is unfavorable since the mechanical strength of the latex-containing layer is insufficient; and the polymer having a too large molecular weight is also unfavorable since its film formability is poor. Also preferred for use herein is a crosslinking polymer latex.

The receiving layer may contain a UV absorbent, a release agent, a lubricant, an antioxidant, a preservative, a surfactant and other additives.

Preferably, the polymer latex for use herein is one miscible with dye for receiving the dye transferred from a thermal transfer sheet; but on the other hand, it is preferably one immiscible with the binder in which a dye is dispersed in a thermal transfer sheet. In case where a polymer latex miscible with dye is used, then the maximum transfer density increases and an image of good contrast can be formed. In case where a polymer latex miscible with the binder in which a dye is dispersed in a thermal transfer sheet is used and when the thermal transfer sheet and the thermal transfer receiving sheet are put one upon another, then heated and peeled, they give a noise in peeling. The polymer latex more miscible with the binder gives a larger peeling noise, and finally the receiving sheet may have a peeling line (banding) when the thermal transfer sheet is peeled away from it.

The monomer to be used in producing the polymer latex in the invention is not specifically defined. As the monomer polymerizable in ordinary radical polymerization or ionic polymerization, preferred are those of the above-mentioned monomer groups (a) to (i). These monomers may be combined independently and in any desired manner to produce the intended polymer latex.

Some polymer latex usable in the invention is commercially available, and the following polymers are usable herein. Examples of acrylic polymers are Daicel Chemical Industry's Sevian A-4635, 4601; Nippon Zeon's Nipol Lx811, 814, 821, 820, 855 (P-17: Tg 36° C.), 857×2 (P-18: Tg 43° C.); Dai-Nippon Ink Chemical's Voncoat R3370 (P-19: Tg 25° C.), 4280 (P-20: Tg 15° C.); Nihon Junyaku's Jurymer ET-410 (P-21: Tg 44° C.); JSR's AE116 (P-22: Tg 50° C.), AE119 (P-23: Tg 55° C.), AE121 (P-24: Tg 58° C.), AE125 (P-25: Tg 60° C.), AE134 (P-26: Tg 48° C.), AE137 (P-27: Tg 48° C.), AE140 (P-28: Tg 53° C.), AE173 (P-29: Tg 60° C.); To a Gosei's Aron A-104 (P-30: Tg 45° C.); Takamatsu Yushi's NS-600X, NS-620X; Nisshin Chemical Industry's Vinybran 2580, 2583, 2641, 2770, 2770H, 2635, 2886, 5202C, 2706; etc. (These are all trade names.)

Examples of polyesters are Dai-Nippon Ink Chemical's FINETEX ES650, 611, 675, 850; Eastman Chemical's WD-size, WMS; Takamatsu Yushi's A-110, A-115GE, A-120, A-21, A-124GP, A-124S, A-160P, A-210, A-215GE, A-510, A-513E, A-515GE, A-520, A-610, A-613, A-615GE, A-620, WAC-10, WAC-15, WAC-17XC, WAC-20, S-110, S-110EA, S-111SL, S-120, S-140, S-140A, S-250, S-252G, S-250S, S-320, S-680, DNS-63P, NS-122L, NS-122LX, NS-244LX, NS-140L, NS-141LX, NS-282LX; To a Gosei's Aron Melt PES-1000 series, PES-2000 series; Toyobo's Vylonal MD-1100, MD-1200, MD-1220, MD-1245, MD-1250, MD-1335, MD-1400, MD-1480, MD-1500, MD-1930, MD-1985; Sumitomo Seika's Sepolsion ES; etc. (These are all trade names.)

Examples of polyurethanes are Dai-Nippon Ink Chemical's HYDRAN AP10, AP20, AP30, AP40, 101H, Vondic 1320NS, 1610NS; Dainichi Seika's D-1000, D-2000, D-6000, D-4000, D-9000; Takamatsu Yushi's NS-155X, NS-310A, NS-310X, NS-311X; Daiichi Kogyo Seiyaku's Elastron; etc. (These are all trade names.)

Examples of rubbers are LACSTAR 7310K, 3307B, 4700H, 7132C (all by Dai-Nippon Ink Chemical); Nipol LX416, LX410, LX430, LX435, LX110, LX415A, LX438C, 2507H, LX303A, LX407BP series, V1004, MH5055 (all by Nippon Zeon); etc. (These are all trade names.)

Examples of polyvinyl chlorides are Nippon Zeon's G351, G576; Nisshin Chemical Industry's Vinybran 240, 270, 277, 375, 386, 609, 550, 601, 602, 630, 660, 671, 683, 680, 680S, 681N, 685R, 277, 380, 381, 410, 430, 432, 860, 863, 865, 867, 900, 900GT, 938, 950, SOLBIN C, SOLBIN CL, SOLBIN CH, SOLBIN CN, SOLBIN C5, SOLBIN M, SOLBIN MF, SOLBIN A, SOLBIN AL; Sekisui Chemical Industry's Eslec A, Eslec C, Eslec M; Denki Kagaku Kogyo's Denkavinyl 1000GKT, Denkavinyl 1000L, Denkavinyl 100CK, Denkavinyl 1000A, Denkavinyl 1000LK2, Denkavinyl 1000AS, Denkavinyl 1000GS, Denkavinyl 1000LT3, Denkavinyl 1000D, Denkavinyl 1000W; etc. (These are all trade names.) Examples of polyvinylidene chlorides are Asahi Kasei Kogyo's L502, L513; Dai-Nippon Ink Chemical's D-5071; etc. (These are all trade names.)

Examples of polyolefins are Mitsui Petrochemical's Chemipearl S120, SA100, V300 (P-40: Tg 80° C.); Dai-Nippon Ink Chemical's Voncoat 2830, 2210, 2960; Sumitomo Seika's Zaikthene, Sepolsion G; and examples of copolymer nylons are Sumitomo Seika's Sepolsion PA; etc. (These are all trade names.)

Examples of polyvinyl acetates are Nisshin Chemical Industry's Vinybran 1080, 1082, 1085W, 1108W, 1108S, 1563M, 1566, 1570, 1588C, A22J7-F2, 1128C, 1137, 1138, A20J2, A23J1, A23K1, A23P2E, A68J1N, 1086A, 1086, 1086D, 1108S, 1187, 1241LT, 1580N, 1083, 1571, 1572, 1581, 4465, 4466, 4468W, 4468S, 4470, 4485LL, 4495LL, 1023, 1042, 1060, 1060S, 1080M, 1084W, 1084S, 1096, 1570K, 1050, 1050S, 3290, 1017AD, 1002, 1006, 1008, 1107L, 1225, 1245L, GV-6170, GV-6181, 4468W, 4468S; etc. (These are all trade names.)

These polymer latexes may be used singly, or if desired, two or more of them may be blended and used.

In the invention, especially preferably, at least one receiving layer is formed by coating with a water-base coating liquid. In case where the image-receiving sheet of the invention has plural receiving layers, preferably, all these receiving layers are formed by coating with a water-base coating liquid followed by drying. “Water-base” as referred to herein means that at least 60% by mass of the solvent (dispersion medium) of the coating liquid is water. As the other ingredient than water in the coating liquid, usable is a water-miscible organic solvent including, for example, methyl alcohol, ethyl alcohol, isopropyl alcohol, methyl cellosolve, ethyl cellosolve, dimethylformamide, ethyl acetate, diacetone alcohol, furfuryl alcohol, benzyl alcohol, diethylene glycol monoethyl ether and oxyethyl phenyl ether.

The minimum film formation temperature (MFT) of the polymer latex is preferably from −30° C. to 90° C., more preferably from 0° C. to 70° C.

Preferred examples of the polymer latex in the invention include polylactates, polyurethanes, polycarbonates, polyesters, polyacetals, SBRs, and polyvinyl chlorides. Of those, preferred are polyvinyl chlorides, polyesters, and polycarbonates; and more preferred are polyvinyl chloride and polyesters.

Of polyvinyl chlorides, or that is, polymer latexes containing at least a repetitive unit derived from vinyl chloride, preferred are polymer latexes containing at least 50 mol % of a repetitive unit derived from vinyl chloride, and more preferred are copolymer latexes.

The monomer to copolymerize with vinyl chloride is not specifically defined, and may anyone capable of copolymerizing with vinyl chloride. Especially preferred are vinyl acetate, acrylates and methacrylates. Preferred examples of the polymer include vinyl chloride/vinyl acetate copolymers, vinyl chloride/acrylate copolymers, and vinyl chloride/methacrylate copolymers. Preferably, the alcohol residue of the ester segment of the acrylates has from 1 to 10 carbon atoms, more preferably from 1 to 8 carbon atoms.

The copolymers are not always limited to copolymers of a vinyl chloride ingredient and the above-mentioned preferred monomer (vinyl acetate or acrylate or methacrylate) ingredient, but may contain any other vinyl alcohol ingredient, maleic acid ingredient and the like not detracting from the object of the invention. The other monomer ingredient to constitute the copolymer that comprises vinyl chloride and the above-mentioned preferred monomer as the main monomer ingredients includes vinyl alcohol derivatives such as vinyl alcohol and vinyl propionate; acrylic acid and methacrylic acid, and acrylic acid and methacrylic acid derivatives such as methyl, ethyl, propyl, butyl, and 2-ethylhexyl acrylates and methacrylates; maleic acid and maleic acid derivatives such as diethyl maleate, dibutyl maleate and dioctyl maleate; vinyl ether derivatives such as methyl vinyl ether, butyl vinyl ether, and 2-ethylhexyl vinyl ether; and acrylonitrile, methacrylonitrile, styrene, vinyl acetate, etc. The compositional ratio of vinyl chloride to the above-mentioned preferred monomer in the copolymer may be any desired one; but preferably, the vinyl chloride ingredient accounts for at least 50% by mass of the copolymer. Preferably, the other ingredient than vinyl monomer and the above-mentioned preferred monomer accounts for at most 10% by mass of the copolymer.

Examples of these polyvinyl chlorides include those mentioned in the above; and above all, preferred are Vinybran 240, Vinybran 270, Vinybran 276, Vinybran 277, Vinybran 375, Vinybran 380, Vinybran 386, Vinybran 410, Vinybran 430, Vinybran 432, Vinybran 550, Vinybran 601, Vinybran 602, Vinybran 609, Vinybran 619, Vinybran 680, Vinybran 680S, Vinybran 681N, Vinybran 683, Vinybran 685R, Vinybran 690, Vinybran 860, Vinybran 863, Vinybran 685, Vinybran 867, Vinybran 900, Vinybran 938, Vinybran 950 (all by Nisshin Chemical Industry); and SE132 and S-830 (both by Sumitomo Chemtec).

### (Polyester-Type Polymer)

The polyesters for use herein can be produced through polycondensation of a dicarboxylic acid ingredient (including its derivative) and a diol ingredient (including its derivative). The polyester polymer may contain an aromatic ring and/or an alicyclic ring. For the alicyclic polyester, the technique described in JP-A 5-238167 is effective from the viewpoint of the dye receiving capability and the image stability with it.

In the invention, preferred is a polyester-type polymer produced through polycondensation of at least the above-mentioned dicarboxylic ingredient and the diol ingredient to have a molecular weight (mass-average molecular weight (Mw)) of generally at least about 11000, preferably at least about 15000, more preferably at least about 17000. When a polymer having a too small molecular weight is used, then the modulus of elasticity of the formed receiving layer may be low and the heat resistance thereof may be poor; and if so, the releasability of the image-receiving sheet from the thermal transfer sheet applied thereto would be thereby poor. The molecular weight is preferably higher from the viewpoint of increasing the modulus of elasticity of the formed receiving layer; and therefore, it is not specifically defined so far as it does not have a problem in that it could not dissolve in the solvent of a coating liquid in receiving layer formation, or it does not have any negative influence on the adhesiveness between the receiving layer formed by coating and drying and the support. Preferably, however, the molecular weight is at most about 30000 or so, preferably at most about 25000. For producing the ester-type polymer, employable is any known conventional method.

Saturated polyesters usable herein are, for example, Vylon 200, Vylon 290 and Vylon 600 (all trade names by Toyobo); KA-1038C (trade name by Arakawa Chemical Industry), TP220 and TP235 (both trade names by Nippon Gohsei).

In the invention, the polymer latex is used for receiving the dye transferred from a thermal transfer sheet, and any other polymer may be used in combination with the polymer latex.

The other polymer to be used along with the polymer latex may act to receive a dye, but may also serve as a binder to sustain the polymer latex.

The polymer is preferably transparent or semi-transparent and colorless; and for example, it includes natural resin polymers and copolymers, synthetic resin polymers and copolymers, and other film-forming mediums, for example, gelatins, polyvinyl alcohols, hydroxyethyl celluloses, cellulose acetates, cellulose acetate butyrates, polyvinyl pyrrolidones, casein, starch, polyacrylic acids, polymethylmethacrylic acids, polyvinyl chlorides, polymethacrylic acids, styrene/maleic anhydride copolymers, styrene/acrylonitrile copolymers, styrene/butadiene copolymers, polyvinyl acetals (e.g., polyvinyl formal, polyvinyl butyral), polyesters, polyurethanes, phenoxy resins, polyvinylidene chlorides, polyepoxides, polycarbonates, polyvinyl acetates, polyolefins, and polyamides. The binder may form a coating film from water or an organic solvent or an emulsion.

In case where a polymer latex is used mainly as the above-mentioned binder, apart from the polymer latex used for the purpose of receiving the dye transferred from a thermal transfer sheet, the polymer latex preferably has a glass transition temperature (Tg) falling within a range of from −30° C. to 70° C. from the viewpoint of the working brittleness and the image storability of the image-receiving sheet of the invention, more preferably within a range of from −10° C. to 50° C., even more preferably from 0° C. to 40° C. Two or more different types of polymers may be blended to prepare the binder, and in this case, it is desirable that the weighted mean Tg of the prepared binder, as computed in consideration of the composition thereof, falls within the above range. In case where the polymer blend undergoes phase separation or has a core/shell structure, it is desirable that the weighted mean Tg thereof falls within the above range.

### <Water-Soluble Polymer>

In one embodiment of the invention, the receiving layer may contain a water-soluble polymer.

The water-soluble polymer means that at least 0.05 g of the polymer may dissolve in 100 g of water at 20° C., more preferably at least 0.1 g of the polymer, even more preferably at least 0.5 g, still more preferably at least 1 g of the polymer may dissolve therein. The polymer latex is a dispersion of polymer particles in a dispersion medium, and this differs from the water-soluble polymer discussed herein for use in the invention.

The water-soluble polymer usable in the invention includes natural polymers (polysaccharides, microorganism-derived ones, animal-derived ones), semi-synthetic polymers (cellulose-type ones, starch-type ones, alginic acid-type ones), and synthetic polymers (vinyl-based ones, and others). Typically, the water-soluble polymer usable in the invention includes synthetic polymers such as typically polyvinyl alcohol, natural and semi-synthetic polymers starting from vegetable-derived celluloses or the like, and gelatin, etc.

In the invention, the water-soluble polymer may be referred to as a binder for the purpose of differentiating it from the above-mentioned polymer latex.

Of the water-soluble polymers usable in the invention, natural polymers and semi-synthetic polymers are described in detail. Vegetable-derived polysaccharides include gum arabic, κ-carrageenan, ι-carrageenan, λ-carrageenan, guar gum (Squalon's Supercol, etc.), locust bean gum, pectin, tragacanth, corn starch (National Starch & Chemical's Purity-21, etc.), and phosphorylated starch (National Starch & Chemical's National 78-1898, etc.); microorganisms-derived polysaccharides include xanthane gum (Kelco's Keltrol T, etc.), and dextrin (National Starch & Chemical's Nadex 360, etc.); animal-derived natural polymers include gelatin (Croda's Crodyne B419, etc.), casein, and sodium chondroitin sulfate (Croda's Cromoist CS, etc.); etc. (These are all trade names.) Cellulose-type polymers include ethyl cellulose (ICI's Cellofas WLD, etc.), carboxymethyl cellulose (Daicel's CMC, etc.), hydroxyethyl cellulose (Daicel's HEC, etc.), hydroxypropyl cellulose (Aqualon's Klucel, etc.), methyl cellulose (Henkel's Viscontran, etc.), nitrocellulose (Hercules' Isopropyl Wet, etc.), and cationated cellulose (Croda's Crodacel QM, etc.). (These are all trade names). Starch-type polymers include phosphorylated starch (National Starch & Chemical's National 78-1989, etc.), alginic acid-type polymers include sodium alginate (Kelco's Keltone, etc.), propylene glycol alginate, etc. Other polymers of other groups include cationated guar gum (Alcolac's Hi-care 1000, etc.), sodium hyaluronate (Lifecare Biomedical's Hyalure, etc.). (These are all trade names.)

In the invention, gelatin is one preferred embodiment. Gelatin for use in the invention may have a molecular weight of from 10,000 to 1,000,000. Gelatin for use in the invention may contain an anion such as Cl⁻, and SO₄²⁻. It may contain a cation such as Fe²⁺, Ca²⁺, Mg²⁺, Sn²⁺, and Zn²⁺. Preferably, gelatin is added, after dissolved in water.

Of the water-soluble polymers for use in the invention, synthetic polymers are described in detail. Acrylic polymers include sodium polyacrylate, polyacrylic acid copolymer, polyacrylamide, polyacrylamide copolymer, polydiethylaminoethyl (meth)acrylate quaternary salt or its copolymer, etc.; vinylic polymers include polyvinyl pyrrolidone, polyvinyl pyrrolidone copolymer, polyvinyl alcohol, etc.; and other polymers include polyethylene glycol, polypropylene glycol, polyisopropylacrylamide, polymethyl vinyl ether, polyethyleneimine, polystyrenesulfonic acid or its copolymer, naphthalenesulfonic acid condensate salt, polyvinylsulfonic acid or its copolymer, polyacrylic acid or its copolymer, acrylic acid or its copolymer, maleic acid copolymer, maleic acid monoester copolymer, acryloylmethylpropanesulfonic acid or its copolymer, polydimethyldiallylammonium chloride or its copolymer, polyamidine or its copolymer, polyimidazolidine, dicyandiamide condensate, epichlorohydrin/dimethylamine condensate, polyacrylamide Hoffman decomposate, water-soluble polyesters (Goo Chemical's Plascoat Z-221, Z-446, Z-561, Z-450, Z-565, Z-850, Z-3308, RZ-105, RZ-570, Z-730, RZ-142 (all trade names), etc.

Of the water-soluble synthetic polymers for use in the invention, preferred are polyvinyl alcohols.

Highly-absorbing polymers described in U.S. Pat. No. 4,960,681 and JP-A 62-245260, or that is, homopolymers of a vinyl monomer having —COOM or —SO₃M (M represents a hydrogen atom or an alkali metal) or copolymers of those vinyl monomers or such a vinyl monomer and any other vinyl monomer (e.g., sodium methacrylate, ammonium methacrylate, Sumitomo Chemical's Sumikagel L-5H (trade name)) are also usable herein.

Of the water-soluble synthetic polymers for use in the invention, preferred are polyvinyl alcohols.

Polyvinyl alcohols are described in more detail hereinunder.

Completely saponified polyvinyl alcohols include PVA-105 [polyvinyl alcohol (PVA) content, at least 94.0% by mass; degree of saponification, 98.5±0.5 mol %; sodium acetate content, at most 1.5% by mass; volatile content, at most 5.0% by mass; viscosity (4% by mass, 20° C.), 5.6±0.4 CPS]; PVA-110 [PVA content, 94.0% by mass; degree of saponification, 98.5±0.5 mol %; sodium acetate content, at most 1.5% by mass; volatile content, 5.0% by mass; viscosity (4% by mass, 20° C.), 11.0±0.8 CPS]; PVA-117 [PVA content, 94.0% by mass; degree of saponification, 98.5±0.5 mol %; sodium acetate content, 1% by mass; volatile content, 5.0% by mass; viscosity (4% by mass, 20° C.), 28.0±3.0 CPS];

PVA-117H [PVA content, 93.5% by mass; degree of saponification, 99.6±0.3 mol %; sodium acetate content, 1.85% by mass; volatile content, 5.0% by mass; viscosity (4% by mass, 20° C.), 29.0±3.0 CPS]; PVA-120 [PVA content, 94.0% by mass; degree of saponification, 98.5±0.5 mol %; sodium acetate content, 1.0% by mass; volatile content, 5.0% by mass; viscosity (4% by mass, 20° C.), 39.5±4.5 CPS]; PVA-124 [PVA content, 94.0% by mass; degree of saponification, 98.5±0.5 mol %; sodium acetate content, 1.0% by mass; volatile content, 5.0% by mass; viscosity (4% by mass, 20° C.), 60.0±6.0 CPS];
PVA-124H [PVA content, 93.5% by mass; degree of saponification, 99.6±0.3 mol %; sodium acetate content, 1.85% by mass; volatile content, 5.0% by mass; viscosity (4% by mass, 20° C.), 61.0±6.0 CPS]; PVA-CS [PVA content, 94.0% by mass; degree of saponification, 97.5±0.5 mol %; sodium acetate content, 1.0% by mass; volatile content, 5.0% by mass; viscosity (4% by mass, 20° C.), 27.5±3.0 CPS]; PVA-CST [PVA content, 94.0% by mass; degree of saponification, 96.0±0.5 mol %; sodium acetate content, 1.0% by mass; volatile content, 5.0% by mass; viscosity (4% by mass, 20° C.), 27.0±3.0 CPS]; PVA-HC [PVA content, 90.0% by mass; degree of saponification, at least 99.85 mol %; sodium acetate content, 2.5% by mass; volatile content, 8.5% by mass; viscosity (4% by mass, 20° C.), 25.0±3.5 CPS] (all Kuraray's trade names); etc.

Partially saponified polyvinyl alcohols include PVA-203 [PVA content, 94.0% by mass; degree of saponification, 88.0±1.5 mol %; sodium acetate content, 1.0% by mass; volatile content, 5.0% by mass; viscosity (4% by mass, 20° C.), 3.4±0.2 CPS];

PVA-204 [PVA content, 94.0% by mass; degree of saponification, 88.0±1.5 mol %; sodium acetate content, 1.0% by mass; volatile content, 5.0% by mass; viscosity (4% by mass, 20° C.), 3.9±0.3 CPS]; PVA-205 [PVA content, 94.0% by mass; degree of saponification, 88.0±1.5 mol %; sodium acetate content, 1.0% by mass; volatile content, 5.0% by mass; viscosity (4% by mass, 20° C.), 5.0±0.4 CPS];
PVA-210 [PVA content, 94.0% by mass; degree of saponification, 88.0±1.0 mol %; sodium acetate content, 1.0% by mass; volatile content, 5.0% by mass; viscosity (4% by mass, 20° C.), 9.0±1.0 CPS]; PVA-217 [PVA content, 94.0% by mass; degree of saponification, 88.0±1.0 mol %; sodium acetate content, 1.0% by mass; volatile content, 5.0% by mass; viscosity (4% by mass, 20° C.), 22.5±2.0 CPS]; PVA-220 [PVA content, 94.0% by mass; degree of saponification, 88.0±1.0 mol %; sodium acetate content, 1.0% by mass; volatile content, 5.0% by mass; viscosity (4% by mass, 20° C.), 30.0±3.0 CPS];
PVA-224 [PVA content, 94.0% by mass; degree of saponification, 88.0±1.5 mol %; sodium acetate content, 1.0% by mass; volatile content, 5.0% by mass; viscosity (4% by mass, 20° C.), 44.0±4.0 CPS];
PVA-228 [PVA content, 94.0% by mass; degree of saponification, 88.0±1.5 mol %; sodium acetate content, 1.0% by mass; volatile content, 5.0% by mass; viscosity (4% by mass, 20° C.), 65.0±5.0 CPS]; PVA-235 [PVA content, 94.0% by mass; degree of saponification, 88.0±1.5 mol %; sodium acetate content, 1.0% by mass; volatile content, 5.0% by mass; viscosity (4% by mass, 20° C.), 95.0±15.0 CPS];
PVA-217EE [PVA content, 94.0% by mass; degree of saponification, 88.0±1.0 mol %; sodium acetate content, 1.0% by mass; volatile content, 5.0% by mass; viscosity (4% by mass, 20° C.), 23.0±3.0 CPS]; PVA-217E [PVA content, 94.0% by mass; degree of saponification, 88.0±1.0 mol %; sodium acetate content, 1.0% by mass; volatile content, 5.0% by mass; viscosity (4% by mass, 20° C.), 23.0±3.0 CPS]; PVA-220E [PVA content, 94.0% by mass; degree of saponification, 88.0±1.0 mol %; sodium acetate content, 1.0% by mass; volatile content, 5.0% by mass; viscosity (4% by mass, 20° C.), 31.0±4.0 CPS];
PVA-224E [PVA content, 94.0% by mass; degree of saponification, 88.0±1.0 mol %; sodium acetate content, 1.0% by mass; volatile content, 5.0% by mass; viscosity (4% by mass, 20° C.), 45.0±5.0 CPS]; PVA-403 [PVA content, 94.0% by mass; degree of saponification, 80.0±1.5 mol %; sodium acetate content, 1.0% by mass; volatile content, 5.0% by mass; viscosity (4% by mass, 20° C.), 3.1±0.3 CPS]; PVA-405 [PVA content, 94.0% by mass; degree of saponification, 81.5±1.5 mol %; sodium acetate content, 1.0% by mass; volatile content, 5.0% by mass; viscosity (4% by mass, 20° C.), 4.8±0.4 CPS];
PVA-420 [PVA content, 94.0% by mass; degree of saponification, 79.5±1.5 mol %; sodium acetate content, 1.0% by mass; volatile content, 5.0% by mass]; PVA-613 [PVA content, 94.0% by mass; degree of saponification, 93.5±1.0 mol %; sodium acetate content, 1.0% by mass; volatile content, 5.0% by mass; viscosity (4% by mass, 20° C.), 16.5±2.0 CPS]; L-8 [PVA content, 96.0% by mass; degree of saponification, 71.0±1.5 mol %; sodium acetate content, 1.0% by mass (ash); volatile content, 3.0% by mass; viscosity (4% by mass, 20° C.), 5.4±0.4 CPS] (all Kuraray's trade names); etc.

The above-mentioned data were found according to JIS K-6726-1977.

As modified polyvinyl alcohols, herein usable are those described in Koichi Nagano, et al's “Poval” (published by the Polymer Publishing Association”. Polyvinyl alcohol may be modified with a cation, an anion, an —SH compound, an alkylthio compound or a silanol.

Modified polyvinyl alcohols (modified PVAs) include C polymers such as C-118, C-318, C-318-2A and C-506 (all Kuraray's trade names); HL polymers such as HL-12E and HL-1203 (both Kuraray's trade names); HM polymers such as HM-03 and HM-N-03 (both Kuraray's trade names); K polymers such as KL-118, KL-318, KL-506, KM-118T and KM-618 (all Kuraray's trade names); M polymers such as M-115 (Kuraray's trade name); MP polymers such as MP-102, MP-202 and MP-203 (all Kuraray's trade names); MPK polymers such as MPK-1, MPK-2, MPK-3, MPK-4, MPK-5 and MPK-6 (all Kuraray's trade names); R polymers such as R-1130, R-2105 and R-2130 (all Kuraray's trade names); and V polymers such as V-2250 (Kuraray's trade name).

The viscosity of an aqueous solution of polyvinyl alcohol may be controlled and stabilized by a slight amount of a solvent or an inorganic salt to be added to the solution. Its details are described in the above-mentioned reference, Koichi Nagano, et al's “Poval” (published by Polymer Publishing Association), pp. 144-154, which is referred to herein. One typical example is adding boric acid to an aqueous PVA solution, whereby the coated area quality may be improved. Preferably, the amount of boric acid to be added is from 0.01 to 40% by mass of polyvinyl alcohol.

In the invention, the water-soluble polymer is preferably selected from polyvinyl alcohols and gelatin, and is more preferably gelatin. Gelatin for use in the invention may have a molecular weight of from 10,000 to 1,000,000. Gelatin for use in the invention may have an anion such as Cl⁻ or SO₄²⁻ and may have a cation such as Fe²⁺, Ca²⁺, Mg²⁺, Sn²⁺ or Zn²⁺. Preferably, gelatin is added, after dissolved in water.

### <Polymerization Method>

Other polymers than water-soluble polymer that are usable as a binder in the invention may be produced with ease according to a solution polymerization method, a suspension polymerization method, an emulsion polymerization method, a dispersion polymerization method, an anionic polymerization method, a cationic polymerization method or the like. Most preferred is an emulsion polymerization method capable of producing a latex polymer. Also preferred is a method comprising preparing a polymer in a solution, then neutralizing it or adding an emulsifying agent thereto, and thereafter adding water and forcedly stirring it to prepare an aqueous dispersion. The emulsion polymerization method is, for example, as follows: Water, or a mixed solvent of water and an organic solvent miscible with water (e.g., methanol, ethanol, acetone) is used as a dispersion medium; a monomer mixture in an amount of from 5 to 150% by mass of the dispersion medium relative to the total amount of the monomer, and an emulsifying agent and a polymerization initiator are used. The monomer is polymerized with stirring at 30 to 100° C. or so, preferably at 60 to 90° C. for 3 to 24 hours. The conditions of the dispersion medium, the monomer concentration, the amount of the initiator, the amount of the emulsifying agent, the amount of the dispersion medium, the reaction temperature and the monomer addition methods may be suitably determined in consideration of the type of the monomer to be used. Preferably, a dispersant is used, if desired.

Emulsion polymerization may be attained, generally according to the following references.

Taira Okuda & Hiroshi Inagaki's “Synthetic Resin Emulsion” (published by Polymer Publishing Association, 1978); Takaaki Sugimura, Yasuo Kataoka, Soichi Suzuki & Keiji Kasahara's “Application of Synthetic Latex” (published by Polymer Publishing Association, 1993); Soichi Muroi's “Chemistry of Synthetic Latex” (published by Polymer Publishing Association, 1970).

For emulsion polymerization to produce the polymer latex in the invention, any one may be selected from a collective polymerization method, a monomer (continuous, intermittent) addition method, an emulsion addition method, or a seed polymerization method. From the viewpoint of the producibility of latex, preferred are a collective polymerization method, a monomer (continuous, intermittent) addition method, and an emulsion addition method.

The polymerization initiator may be any one having a radical-generating capability, for which, for example, usable are inorganic peroxides such as persulfates and hydrogen peroxide; peroxides described in Nippon Yushi's “Catalogue of Organic Peroxides”; and azo compounds described in Wako Pure Chemicals' “Catalogue of Azo Polymerization Initiators”. Of those, preferred are water-soluble peroxides such as persulfates, and water-soluble azo compounds such as those described in Wako Pure Chemicals' “Catalogue of Azo Polymerization Initiators”; more preferred are ammonium persulfate, sodium persulfate, potassium persulfate, azobis(2-methylpropionamidine) hydrochloride, azobis(2-methyl-N-(2-hydroxyethyl)propionamide), azobiscyanovaleric acid. In particular, even more preferred are peroxides such as ammonium persulfate, sodium persulfate and potassium persulfate from the viewpoint of the image storability, the solubility and the cost.

The amount of the polymerization initiator to be added is preferably from 0.3% by mass to 2.0% by mass relative to the total amount of the monomer, more preferably from 0.4% by mass to 1.75% by mass, even more preferably from 0.5% by mass to 1.5% by mass.

As the polymerization emulsifying agent, usable is any of anionic surfactants, nonionic surfactants, cationic surfactants and ampholytic surfactants; but from the viewpoint of the dispersibility and the image storability, preferred are anionic surfactants. More preferred are sulfonic acid-type anionic surfactants as they can secure good polymerization stability even when used in a small amount, and as they have hydrolysis resistance. Even more preferred are long-chain alkyldiphenyl-ether disulfonic acid salts such as typically Pelex SS-H (Kao's trade name); and especially preferred are low-electrolyte surfactants such as Pionin A-43-S (Takemoto Yushi's trade name).

As the polymerization emulsifying agent, a sulfonic acid-type anionic surfactant is used preferably in an amount of from 0.1% by mass to 10.0% by mass of the total amount of the monomer, more preferably from 0.2% by mass to 7.5% by mass, even more preferably from 0.3% by mass to 5.0% by mass.

For producing the polymer latex in the invention, preferably used is a chelating agent. The chelating agent is a compound a compound coordinated (chelated) with a polyvalent ion, for example, a metal ion such as an iron ion, or an alkaline earth metal ion such as a calcium ion; and for it, for example, herein usable are the compounds described in JP-B 6-8956, U.S. Pat. No. 5,053,322, and JP-A 4-736645, 4-127145, 4-247073, 4-305572, 6-11805, 5-173312, 5-66527, 5-158195, 6-118580, 6-110168, 6-161054, 6-175299, 6-214352, 7-114161, 7-114154, 7-120894, 7-199433, 7-306504, 9-43792, 8-314090, 10-182571, 10-182570, 11-190892.

As the chelating agent, preferred are inorganic chelating compounds (e.g., sodium tripolyphosphate, sodium hexametaphosphate, sodium tetrapolyphosphate), aminopolycarboxylic acid-type chelating compounds (e.g., nitrilotriacetic acid, ethylenediaminetetraacetic acid), organic phosphonic acid-type chelating compounds (e.g., compounds described in Research Disclosure, No. 18170, JP-A 52-102726, 53-42730, 56-97347, 54-121127, 55-4024, 55-4025, 55-29883, 55-126241, 55-65955, 55-65956, 57-179843, 54-61125, and West German Patent 1045373), polyphenol-type chelating agents, and polyamine-type chelating compounds; and more preferred are aminopolycarboxylic acid derivatives.

As preferred examples of the aminopolycarboxylic acid derivatives, mentioned are the compounds given in the attached table of “EDTA (—Chemistry of Complexan)” (by Nankodo, 1977); and a part of the carboxyl group in these compounds may be substituted with an alkali metal salt such as potassium or sodium, or with an ammonium salt. Especially preferred aminocarboxylic acid derivatives are iminodiacetic acid, N-methyliminodiacetic acid, N-(2-aminoethyl)iminodiacetic acid, N-(carbamoylmethyl)iminodiacetic acid, nitrilotriacetic acid, ethylenediamine-N,N′-diacetic acid, ethylenediamine-N,N′-di-α-propionic acid, ethylenediamine-N,N′-di-β-propionic acid, N,N′-ethylene-bis(α-o-hydroxyphenyl)glycine, N,N′-di(2-hydroxybenzyl)ethylenediamine-N,N′-diacetic acid, ethylenediamine-N,N′-diacetic acid-N,N′-diacetohydroxamic acid, N-hydroxyethylethylenediamine-N,N′,N′-triacetic acid, ethylenediamine-N,N,N′,N′-tetraacetic acid, 1,2-propylenediamine-N,N,N′,N′-tetraacetic acid, d,l-2,3-diaminobutane-N,N,N′,N′-tetraacetic acid, meso-2,3-diaminobutane-N,N,N′,N′-tetraacetic acid, 1-phenylethylenediamine-N,N,N′,N′-tetraacetic acid, d,l-1,2-diphenylethylenediamine-N,N,N′,N′-tetraacetic acid, 1,4-diaminobutane-N,N,N′,N′-tetraacetic acid, trans-cyclobutane-1,2-diamine-N,N,N′,N′-tetraacetic acid, trans-cyclopentane-1,2-diamine-N,N,N′,N′-tetraacetic acid, trans-cyclohexane-1,2-diamine-N,N,N′,N′-tetraacetic acid, cis-cyclohexane-1,2-diamine-N,N,N′,N′-tetraacetic acid, cyclohexane-1,3-diamine-N,N,N′,N′-tetraacetic acid, cyclohexane-1,4-diamine-N,N,N′,N′-tetraacetic acid, o-phenylenediamine-N,N,N′,N′-tetraacetic acid, cis-1,4-diaminobutene-N,N,N′,N′-tetraacetic acid, trans-1,4-diaminobutene-N,N,N′,N′-tetraacetic acid, α,α′-diamino-o-xylene-N,N,N′,N′-tetraacetic acid, 2-hydroxy-1,3-propanediamine-N,N,N′,N′-tetraacetic acid, 2,2′-oxy-bis(ethyliminodiacetic acid), 2,2′-ethylenedioxy-bis(ethyliminodiacetic acid), ethylenediamine-N,N′-diacetic acid-N,N′-di-α-propionic acid, ethylenediamine-N,N′-diacetic acid-N,N′-di-β-propionic acid, ethylenediamine-N,N,N′,N′-tetrapropionic acid, diethylenetriamine-N,N,N′,N″,N″-pentaacetic acid, triethylenetetramine-N,N,N′,N″,N′″,N′″-hexaacetic acid, and 1,2,3-triaminopropane-N,N,N′,N″,N′″,N′″-hexaacetic acid. Also mentioned are those derived from the above compounds by substituting a part of the carboxyl group therein with an alkali metal salt such as sodium or potassium or with an ammonium salt.

The amount of the chelating agent to be added is preferably from 0.01% by mass to 0.4% by mass of the total amount of the monomer, more preferably from 0.02% by mass to 0.3% by mass, even more preferably from 0.03% by mass to 0.15% by mass. When the amount of the chelating agent is less than 0.01% by mass, then it may be insufficient to capture the metal ion that may mix in the polymer latex in its production process and the latex stability against aggregation may lower and the latex coatability may worsen. On the other hand, when the amount is more than 0.4% by mass, then the latex viscosity may increase and the latex coatability may worsen.

Preferably, a chain transfer agent is used in producing the polymer latex in the invention. As the chain transfer agent, preferred are those described in “Polymer Handbook”, 3rd. Ed. by Wiley-Interscience (1989). Sulfur compounds are more preferred as having a high chain transfer capability, and their amount to be used may be small. Especially preferred are hydrophobic mercaptan-type chain transfer agents such as tert-dodecylmercaptan and n-dodecylmercaptan.

The amount of the chain transfer agent to be used is preferably from 0.2% by mass to 2.0% by mass of the total amount of the monomer, more preferably from 0.3% by mass to 1.8% by mass, even more preferably from 0.4% by mass to 1.6% by mass.

In emulsion polymerization, other additives than the above-mentioned compounds, for example, those described in Synthetic Rubber Handbook”, such as an electrolyte, a stabilizer, a thickener, a defoaming agent, an antioxidant, a vulcanizing agent, a freezing inhibitor, a gelling agent, and a vulcanization promoter may be used.

As the solvent of the coating liquid that comprises the polymer latex of the invention, a water-base solvent may be used, but a mixed solvent of a water-base solvent and a water-miscible organic solvent may also be used. The water-miscible organic solvent includes, for example, alcohols such as methyl alcohol, ethyl alcohol and propyl alcohol; cellosolves such as methyl cellosolve, ethyl cellosolve and butyl cellosolve; and ethyl acetate, dimethylformamide, etc. The amount of the organic solvent to be added to the mixed solvent is preferably at most 40% of the whole solvent, more preferably at most 30%.

The polymer latex in the invention preferably has a polymer concentration of from 10 to 70% by mass of the latex, more preferably from 20 to 60% by mass, even more preferably from 30 to 55% by mass.

The amount of the polymer latex to be added to the receiving layer is preferably so controlled that solid content of the polymer latex could be from 50 to 95% by mass of the whole polymer in the layer, more preferably from 70 to 90% by mass.

### <Organic Solvent>

The organic solvent to be used in producing the thermal transfer image-receiving sheet of the invention is described.

In producing the thermal transfer image-receiving sheet, an organic solvent having a boiling point of from 140 to 220° C. may be used in the coating liquid for the constitutive layer to be formed on the side of the receiving layer on a support; and the organic solvent has a function of forming a film of the above-mentioned, dye-receiving polymer latex. The organic solvent may be added to the coating liquid of any of the constitutive layer to be formed on the side of the receiving layer on a support. The organic solvent effectively acts for attaining the effect of the invention.

The organic solvent that may be added to the coating liquid for producing the thermal transfer image-receiving sheet of the invention includes, for example, ethyl acetacetate, tetramethyl-sulfone, γ-butyl-lactone, ethylene glycol monomethyl ether acetate, ethylene glycol monobutyl ether, diacetone alcohol, diglyme, dimethyl sulfoxide, diethylene glycol monoethyl ether, diethylene glycol monoethyl ether acetate, diethylene glycol diethyl ether, diethylene glycol monobutyl ether, diethylene glycol monobutyl ether acetate, dipropylene glycol monomethyl ether acetate, dipropylene glycol n-butyl acetate, cyclohexanone, cyclopentanone, ethyl acetate, methyl acetate, butyl acetate, cyclohexyl acetate, 2-heptanone, ethyl pyruvate, 3,5,5-trimethyl-2-cyclohexen-1-one, butyl lactate, propylene glycol, propylene glycol diacetate, propylene glycol n-propyl ether acetate, propylene glycol phenyl ether acetate, propylene glycol monomethyl ether acetate, 2-ethylhexyl acetate, 3-methoxy-3-methylbutyl acetate, tripropylene glycol methylethyl acetate, 1-methoxypropyl acetate, N-methylpyrrolidone, N,N-dimethylacetamide, N,N-dimethylformamide, tetrahydrofurfuryl alcohol, and ethoxypropyl propionate.

In the invention, when the polymer latex to be used contains a plasticizer, the organic solvent includes the plasticizer, and may further include a promoter acting in adding the polymer latex, a dispersion aid to be used in an emulsion dispersion, and a solvent used in forming a heat-insulating layer.

The organic solvent is preferably a water-soluble organic solvent. More preferably, at least 50 g of the solvent dissolves in 100 ml of water, or that is, the two are miscible with each other with no phase separation; and more preferably at least 100 g of the solvent dissolves therein.

The organic solvent includes alcohol-type solvents, ethylene glycol-type solvents, propylene glycol-type solvents, diethylene glycol-type solvents, and those derived from these by etherifying or esterifying the hydroxyl group therein.

For example, there are mentioned ethylene glycol (197.2° C.), propylene glycol (187.3° C.), butyl cellosolve (171.2° C.), methyl cellosolve acetate (144.5° C.), cellosolve acetate (156.3° C.), methyl carbitol (193.2° C.), carbitol (201.9° C.), diethyl carbitol (186.0° C.), carbitol acetate (218.0° C.), diacetone alcohol (168.0° C.).

Preferably, the organic solvent evaporates away during coating, drying or storage; and immediately after production of a thermal transfer image-receiving sheet, or anytime between its production and image formation thereon, it is desirable that the solvent content in all the constitutive layers on the side of the image-receiving layer on a support of the thermal transfer image-receiving is at most 3% (more preferably at most 1%) of the overall solid content of the coating layers.

### <UV Absorbent>

In the invention, a UV absorbent may be added to the receiving layer for improving the light resistance of the sheet. In this, the UV absorbent may be processed to have an increased molecular weight so as to be fixed in the receiving layer to which it is added, whereby the UV absorbent added may be prevented from being diffused or sublimed or evaporated away by heat into thermal transfer sheet.

As the UV absorbent, usable are various UV absorbent skeleton-having compounds well known in the field of information recording. Concretely, there are mentioned compounds having a 2-hydroxybenzotriazole-type UV absorbent skeleton, a 2-hydroxybenzotriazine-type UV absorbent skeleton or a 2-hydroxybenzophenone-type UV absorbent skeleton. From the viewpoint of the UV absorbability (absorption coefficient) and the stability thereof, preferred are benzotriazole-type or triazine skeleton-having compounds; and from the viewpoint of the processability thereof into polymers having an increased molecular weight or for latex formation, preferred are benzotriazole-type or benzophenone-type skeleton-having compounds. Concretely, the UV absorbents described in JP-A 2004-361936 are usable.

Preferably, the UV absorbent absorbs the light falling within a UV range, and its absorption curve end does not step in the visible range. Concretely, when the UV absorbent is added to a receiving layer in producing a thermal transfer image-receiving sheet, it is desirable that the reflection density at 370 nm is at least 0.5 as the absolute value, more preferably, the reflection density at 380 nm is at least 0.5 as the absolute value, and even more preferably the reflection density at 400 nm is at least 0.1 as the absolute value. When the reflection density within a range over 400 nm is high, it is unfavorable since the image may yellow.

In the invention, the UV absorbent to be used is preferably one processed to have an increased molecular weight, and its mass-average molecular weight is preferably at least 10000, more preferably at least 100000. For increasing the molecular weight of the UV absorbent, preferred is a method of grafting the UV absorbent on a polymer. The polymer to be the main chain of the grafted structure preferably has a polymer skeleton of which the dye fixability is inferior to that of the receiving polymer to be used along with it. Also preferably, the branched polymer could have a sufficient film strength when formed into a film. The grafting ratio of the UV absorbent on the polymer main chain is preferably from 5 to 20% by mass, more preferably from 8 to 15% by mass.

More preferably, the UV absorbent-grafted polymer is formed into a latex. The water-dispersed coating liquid of the polymer latex may be formed into a receiving layer by coating, and the production cost may be thereby reduced. For forming the polymer latex, for example, employable is the method described in Japanese Patent 3450339. As the UV absorbent polymer latex, commercial products may be used, including, for example, Ipposha Yushi's ULS-700, ULS-1700, ULS-1383MA, ULS-1635 MH, XL-7016, ULS-933LP, and ULS-935LH, and Shin-Nakamura Chemical's New Coat UVA-1025W, New Coat UVA-204W, and New Coat UVA-4512M (all trade names).

In case where a UV absorbent-grafted polymer is formed into a latex thereof, it may be mixed with the above-mentioned dye-receiving polymer latex and then formed into a receiving layer by coating, whereby the UV absorbent may be uniformly dispersed in the formed receiving layer.

The amount of the UV absorbent-grafted polymer or its latex to be added is preferably from 5 to 50 parts by mass of the dye-receiving polymer to form the receiving layer, more preferably from 10 to 30 parts by mass.

### <Release Agent>

In case where the image-receiving surface of the thermal transfer image-receiving sheet could not have a sufficient releasing ability, the thermal transfer image-receiving sheet (image-receiving sheet) and a thermal transfer sheet attached thereto may fuse together by heat of a thermal head whereby there may occur various failed transfer problems in that a large peeling noise may occur in peeling the two, or the dye layer may be all transferred onto the receiving sheet, or the receiving layer may peel off from the substrate.

To prevent the problems by thermal fusion, a release agent may be incorporated. As the release agent, usable are silicone oils, phosphate plasticizers, fluorine compounds, and various wax dispersions; and preferred are silicone oils.

As the silicone oils, preferred are modified silicone oils such as epoxy-modified, alkyl-modified, amino-modified, carboxyl-modified, alcohol-modified, fluorine-modified, alkylaralkyl-polyether-modified, epoxy-polyether-modified or polyether-modified ones. Above all, more preferred are reaction products of a vinyl-modified silicone oil and a hydrogen-modified silicone oil. The amount of the release agent to be added is preferably from 0.2 to 30 parts by mass of the receiving polymer.

The lubricant described in the section of “emulsion” given hereinunder has nearly the same effect as that of the release agent described in this section, and the two have nearly the same meaning. In the invention, one that is used as its dispersion is referred to as a lubricant emulsion for convenience sake, and the others are described as release agent in this section.

### <Emulsion>

Hydrophobic additives such as lubricant and antioxidant may be introduced into the layers (e.g., receiving layer, heat-insulating layer, interlayer, undercoat layer) of the thermal transfer image-receiving sheet according to a known method, for example, according to the method described in U.S. Pat. No. 2,322,027. In this case, a high-boiling-point solvent as in U.S. Pat. No. 4,555,470, 4,536,466, 4,563,467, 4,587,206, 4,555,476, 4,599,296, and JP-B 3-62256 may be used optionally along with a low-boiling-point solvent having a boiling point of from 50° C. to 160° C. Two or more different types of such lubricants, antioxidants and high-boiling-point solvents may be used, each as combined.

The lubricant includes, for example, solid waxes such as polyethylene wax, wax amide, and Teflon powder; silicone oils, phosphate compounds, fluorine-containing surfactants, silicone-type surfactants and other lubricants known in the art. Preferred are various waxes; fluorine compounds such as typically fluorine-containing surfactants; and silicone compounds such as silicone-type surfactants, silicone oils and/or their cured products.

### <Surfactant>

The thermal transfer image-receiving sheet of the invention may contain a surfactant in any layers thereof mentioned above. Preferably, the surfactant is in the receiving layer and the interlayer of the sheet.

The amount of the surfactant is preferably from 0.01 to 5% by weight of the total solid content of the layer, more preferably from 0.01 to 1% by mass, even more preferably from 0.02 to 0.2% by mass.

Various surfactants are known, such as anionic, nonionic and cationic surfactants. Any known surfactant may be used in the invention, and for example, those introduced in “Functional Surfactants” (edited by Mitsuo Kadota, issued in August 2000), Chap. 6 may be used. In particular, anionic fluorine-containing surfactants are preferred.

Even though not containing a surfactant, the coating with the coating liquid may be possible; however, since the surface tension of the coating liquid is high, the coating surface may be rough and uneven. The surfactant added to the coating liquid may lower the surface tension of the coating liquid, thereby removing coating unevenness, and therefore the coated surface is uniform and stable coating is possible.

Specific examples of fluorine compounds are shown below; however, the fluorine compounds usable in the invention should not be limited to these examples. In the expression of the structures of the following compounds, the alkyl group and the perfluoroalkyl group have a linear structure unless otherwise specifically indicated.

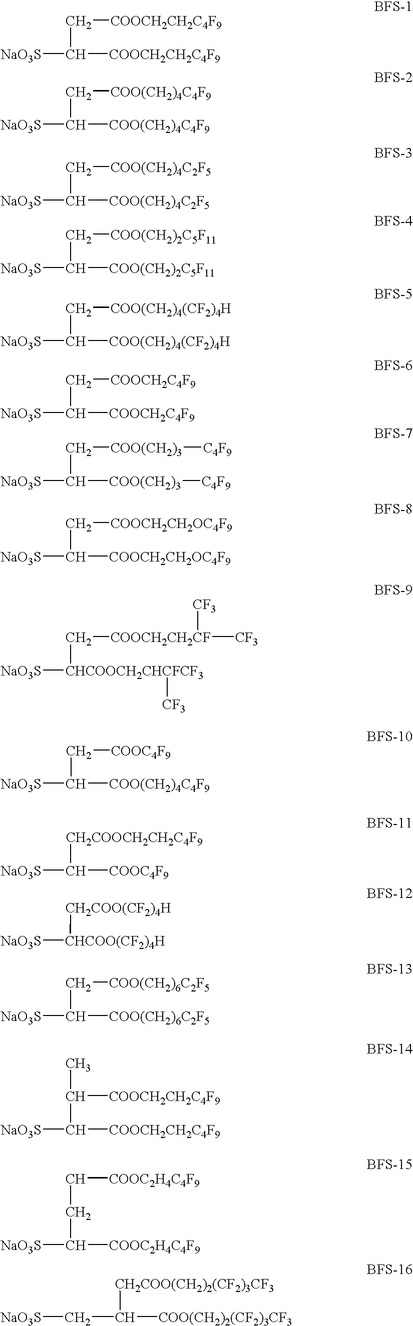

These fluorine compounds may be used as a surfactant in coating compositions to form the layers constituting the thermal transfer image-receiving sheet (especially, receiving layer, heat-insulating layer, interlayer, undercoat layer, back layer, etc.); and in the invention, the compound is preferably incorporated in the receiving layer and the interlayer.

### <Mat Agent>

In the invention, a mat agent is preferably added for making the sheet releasable. Preferably, the mat agent is added to the outermost surface layer or to the layer functioning as an outermost surface layer, or to the layer near to the outermost surface of the sheet. The outermost surface layer may be optionally double-layered. Most preferably, the mat agent is added to the receiving layer existing as the outermost layer. The mat agent may be added to any of the outermost layer of the image-forming layer surface or the outermost layer of the back of the sheet, or may be added to both the two. Especially preferably, the mat agent is added to the layer on the side containing a lubricant, relative to the support.

Preferably, the mat agent is previously dispersed with a binder and the resulting dispersion of mat agent particles is used.

In general, the mat agent includes fine particles of a water-insoluble organic compound or inorganic compound; and in the invention, preferred are fine particles containing an organic compound from the viewpoint of their dispersibility. The fine particles containing an organic compound may be fine particles of an organic compound alone or organic/inorganic composite fine particles containing not only an organic compound but also an inorganic compound. Examples of the mat agent are described, for example, in U.S. Pat. No. 1,939,213, 2,701,245, 2,322,037, 3,262,782, 3,539,344, 3,767,448; and those well known in the field of silver salt photographic materials are usable in the invention.

In image printing, the temperature of the surface of the receiving layer rises high, and therefore the mat agent is preferably resistant to heat. In particular, preferred is a polymer having a thermal decomposition temperature of not lower than 200° C. More preferred is a polymer having a thermal decomposition temperature of not lower than 240° C.

In image printing, not only heat but also pressure is given to the surface of the receiving layer, and therefore, the mat agent is preferably hard.

The mat agent in the outermost layer and the layer adjacent to the outermost layer on the side of the image-forming layer is previously dispersed with a binder, and the resulting dispersion of mat agent particles is added to the layer. For dispersing the mat agent particles, employable are two methods of (a) a method of preparing a polymer to be the mat agent as a solution thereof (for example, by dissolving the polymer in a low-boiling-point organic solvent), then emulsifying and dispersing it in an aqueous medium to give liquid drops of the polymer, and then removing the low-boiling-point organic solvent from the emulsion to produce a dispersion of the mat agent, and (b) a method of preparing fine particles of a polymer to be the mat agent, and then dispersing them to form a dispersion with no unmixed lump therein. In the invention, the method (b) is preferred from the viewpoint of environmental protection, as not releasing a low-boiling-point organic solvent in the environment.

The dispersion of mat agent particles for use in the invention is stabilized when it contains a surfactant, and therefore a surfactant is preferably added thereto.

### <Preservative>

While the coating liquid, the image-receiving sheet and the image printed matter are stored, microorganisms (especially bacteria, fungi, yeasts, etc.) may adhere to them to worsen their quality. To prevent it, a preservative may be added to them within a range not having any negative influence on the other properties thereof.

The preservative as referred to herein means a material that is used for protecting the compounds used in the image-receiving sheet from being decomposed by the growth of such microorganisms, and its definition based on formulae thereof and concrete compounds of the material are described in “Preservative Antifungal Handbook” written by Hiroshi Horiguchi and published by Gihodo Shuppan Co., Ltd. (1986); “Antibacterial Antifungal Chemistry” published by Sankyo (1986); “Encyclopedia of Antibacterial Antifungal Agents” published by the Antibacterial Antifungal Society of Japan (1986), etc.

Not specifically defined, the preservative to be in the image-receiving sheet of the invention includes phenol or its derivatives, formalin, imidazole derivatives, sodium dehydroacetate, 4-isothiazolin-3-one derivatives, benzoisothiazolin-3-one, benzotriazole derivatives, amidine-guanidine derivatives, quaternary ammonium salts, pyrrolidine, quinoline or guanidine derivatives, diazine or triazole derivatives, oxazole or oxazine derivatives, 2-mercaptopyridine-N-oxide or its salts, formaldehyde donor-type antibacterial agents, etc. Of those, preferred are phenol or its derivatives, 4-isothiazolin-3-one derivatives, benzoisothiazolin-3-one, etc.

One or more different types of preservatives may be used either singly or as combined. The preservative may be directly added to the material as it is, but it may be dissolved in water or in an organic solvent such as methanol, ethanol, isopropyl alcohol, acetone, ethylene, ethylene glycol or the like, and the resulting solution may be added to the coating liquid for the image-receiving sheet. It may be added to a latex. As the case may be, it may be dissolved in a high-boiling-point solvent, a low-boiling-point solvent or a mixed solvent of the two, and thereafter the resulting solution may be emulsified and dispersed in the presence of a surfactant, and may be added to a latex.

### <Defoaming Agent>

The defoaming agent for use in the invention means a compound that exists by itself in the surface of a liquid in place of a substance to cause foam formation, but does not have by itself an action of producing a repulsion to be resistant to thinning of foam walls. Concretely, for example, it includes alcohols, ethers, polyols, fatty acid esters, metal soaps, phosphates, silicones, as well as nonionic surfactants, etc. Of commercial defoaming agents and compounds having such structures, any ones having a defoaming effect can be used either singly or as combined.

### (A) Alcohols:

There are mentioned aliphatic alcohols having from 1 to 10 carbon atoms, such as methanol, ethanol, butanol, octanol, and 2-ethylhexanol.

However, an aliphatic alcohol having from 1 to 3 carbon atoms is unfavorable since it must be added in an amount of at least 1% in order to surely exhibit its effect and it may swell latex and hollow polymer to promote their aggregation; and therefore, fatty alcohols having at least 4 carbon atoms are preferred.

### (B) Fatty Acid Esters:

There are mentioned isoamyl stearate, succinic diesters, sorbitan lauric monoester, sorbitan oleic monoester, sorbitan oleic triester, oxyethylene sorbitan lauric monoester, diethylene glycol distearate, as well as low-molecular-weight polyethylene glycol oleates, etc.

### (C) Ethers:

There are mentioned ethylene glycol monophenyl ethers (e.g., di-tert-diaminophenoxyethanol), ethylene glycol dialkyl ethers (e.g., 3-heptyl cellosolve, nonyl cellosolve), diethylene glycol dialkyl ethers (e.g., 3-heptyl carbitol), etc. As commercial products, for example, usable are Bionine K-17 (by Takemoto Yushi), and Nopco DF122-NS (by San Nopco).

### (D) Polyols:

There are mentioned compounds having many alkylene oxide groups (especially ethylene oxide groups) in the molecule thereof. These compounds have excellent dispersion stability in water, and therefore have excellent anti-foaming effect in liquid. As commercial products of polyether-type defoaming agents, for example, usable are Adeka Pulronic series and Adekanol series LG-109, LG-121, LG-294, and LG-297 (by Asahi Denka Kogyo), and SN Deformer 157, 247, 375, and 470 (by San Nopco).

### (E) Metal Soaps:

Various organic acid metal soaps are usable, and for example, there are mentioned naphthenic acid-base metal soaps, synthetic acid-base metal soaps, stearic acid-base metal soaps, etc. Concretely, there are mentioned aluminium stearate, and naphthenates, Dicnates and stearates (all by Dai-Nippon Ink Chemical Industry), etc.

### (F) Silicones:

There are mentioned oil-type, compound-type, self-emulsifying or emulsion-type silicone defoaming agents, etc. In particular, oil-type silicones include ordinary dimethylpolysiloxane structure-having silicone oils, as well as modified silicone oils in which a part of the methyl groups are modified such as, for example, amino-modified, epoxy-modified, carboxyl-modified, carbinol-modified, methacrylic-modified, mercapto-modified, phenol-modified, heterofunctional group-modified, polyether-modified, methylstyryl-modified, alkyl-modified, higher fatty acid ester-modified, hydrophilic special-modified, higher alkoxy-modified, higher fatty acid-containing, or fluorine-modified silicone oils. Commercial products are available. As oil-type commercial products, there are mentioned SH200 (by Toray Dow Corning Silicone), KF96, KS604, and KI-6702 (by Shin-etsu Silicone); as compound-type ones, there are SN Defoamer 5016 (by San Nopco), SH5500 and SC5540 (by Toray Dow Corning Silicone); as self-emulsifying ones, there are BY28-503 (by Toray Dow Corning Silicone), KS508, KS530 and KS-538 (by Shin-etsu Silicone); and as emulsion type ones, there are SM5511, SM5512 and SM5515 (by Toray Dow Corning Silicone), KM72, KM73 and KM98 (by Shin-etsu Silicone). As modified silicone oils, there are mentioned amino-modified SF5417, epoxy-modified SF8411 and SF8413, carboxyl-modified BY16-880 and fluorine-modified FS1265 (all by Toray Dow Corning Silicone), polyether-modified KF6017 (by Shin-etsu Silicone), alkyl-modified/polyether-modified FORM BAN MS-575 (by Ultra Additives Inc.), carbinol-modified KF-6001 and KF-6003 (by Shin-etsu Silicone), etc.

### (G) Nonionic Surfactants:

The following examples (1) to (4) are mentioned.

(1) Alkyl aryl ether-ethyleneoxide adducts.
(2) Compounds of a formula, HO—(C₂H₄O)n-(C₃H₆O)m-(C₂H₄O)n-OH, having a molecular weight of from 500 to 10000 and having a C₂H₄O content of from 0 to 55%.
(3) Alkyl ester compounds of a formula, R¹(R²)CHCOO(C₂H₄O)n (wherein R¹ and R² each represents an alkyl group having from 1 to 15 carbon atoms, and n indicates from 1 to 8). In this, preferably, R¹ and R² each have at least 5 carbon atoms, more preferably at least 10 carbon atoms.
(4) Acetylene-diols, and their ethyleneoxide (0 to 8 mols) adducts.

One or more different types of those defoaming agents may be used in the invention either singly or as combined.

Of the above-mentioned defoaming agents (A) to (G) that may be used for defoaming the coating liquids in the invention, the silicones (F) and the nonionic surfactants (G) have some troublesome problems in that the silicones (F) may change the viscoelasticity of films and may promote the adhesion to thermal transfer sheets, while the effect of the nonionic surfactants (G) depends on temperature, and therefore they could not exhibit the effect when the temperature of the coating liquid is not severely controlled. Accordingly, for use in the invention, preferred are the above-mentioned defoaming agents (A) to (E). The amount of the defoaming agent to be used is preferably from 0.01 to 5% by mass for exhibiting its defoaming effect not aggregating latex and hollow particles, more preferably from 0.1 to 1% by mass.

The coating amount of the receiving layer is preferably from 0.5 to 10 g/m² (in terms of the solid content of the layer—unless otherwise specifically indicated in the invention, the coating amount is in terms of the solid content of the coating layer). Preferably, the thickness of the receiving layer is from 1 to 20 μm.

### (Interlayer)

An interlayer may be formed between the receiving layer and the support; an for example, a white background-controlling layer, a charge-controlling layer, an adhesive layer, a primer layer, and an undercoat layer may be formed. For example, the constitutions of these layers may be the same as those described in Japanese Patents 3585599 and 2925244.

### (Heat-Insulating Layer)

The heat-insulating layer plays a role of protecting the support from heat in thermal transfer with a thermal head or the like. In addition, since it has good cushionability, the thermal transfer image-receiving sheet may have good printing sensitivity even though paper is used as the support. The heat-insulating layer may be a single layer or a two-layered one. The heat-insulating layer is disposed nearer to the support than the receiving layer.

In the thermal transfer image-receiving sheet of the invention, the heat-insulating layer contains the hollow particle latex of the invention.

Preferably, the mean particle size of the hollow particles is from 0.1 to 5.0 μm, more preferably from 0.2 to 3.0 μm, even more preferably from 0.3 to 1.5 μm.

When the size is too small, then the porosity of the layer mow lower and the layer could not attain the desired heat-insulating effect; but when too large, then the particle size of the hollow polymer particles may be too large relative to the thickness of the heat-insulating layer and the layer could not have a smooth surface, and if so, the sheet may often have coating failures caused by the coarse particles.

Preferably, the hollow particles could produce a porosity of from 10 to 70% or so, more preferably from 20 to 70%. When the porosity is too small, then the layer could not attain the desired heat-insulating effect; but when too large, then the proportion of easily cracking hollow polymer particles and incomplete hollow particles may increase, therefore causing printing failures, and, in addition, the film could not have a sufficient film strength.

In the invention, the size of the hollow particles may be determined by measuring the circle-corresponding diameter of the outer size of each particle, using a transmission electronic microscope. Concretely, at least 300 hollow particles are observed with a transmission electronic microscope, and the circle-corresponding diameter of their outer size is computed. The data are averaged to obtain the particle size. The porosity of the hollow particles may also be determined by measuring the outer diameter and the inner diameter thereof with a transmission electronic microscope. Concretely, like in the above-mentioned particle size measurement, at least 300 hollow particles are observed with a transmission electronic microscope, and their porosity is computed. The data are averaged to obtain the porosity of the hollow particles. The porosity in the invention means the ratio of the pore part to the volume of the pore-containing hollow particle.

In the invention, preferably, the solid content except the hollow particles in the heat-insulating layer is at most 30% by mass, more preferably from 5 to 20%. The solid content except the hollow particles is the total of the solid content of the binder, the inorganic base and others except the hollow particles in the heat-insulating layer.

If desired, two or more different types of hollow polymers may be used as combined. Their concrete examples include Rohm & Haas' Rohpake 1055, Dai-Nippon ink's Boncoat PP-1000, JSR's SX866(B), Nippon Zeon's Nipol MH5055 (all trade names), Matsumoto Yushi Seiyaku's F-30 and F-50 (both trade names), Matsumoto Yushi Seiyaku's F-30E, Nippon Ferrite's Expancel 461DE, 551DE and 551DE20 (all trade names), etc. The hollow polymer to be in the heat-insulating layer may be in the form of its latex.

Preferably, the hollow particle latex-containing, heat-insulating layer contains a water-dispersible resin or a water-soluble resin as a binder, apart from the hollow particle latex. The binder resin usable in the invention may be any known resin including acrylic resin, styrene/acryl copolymer, polystyrene resin, polyvinyl alcohol resin, vinyl acetate resin, ethylene/vinyl acetate copolymer, vinyl chloride/vinyl acetate copolymer, styrene/butadiene copolymer, urethane resin, polyvinylidene chloride resin, cellulose derivative, casein, starch, gelatin, etc. For these, preferred are the water-soluble polymers described in the section of the receiving layer. Of those binder resins, more preferred are gelatin, polyvinyl alcohol, styrene/butadiene copolymer and urethane resin; and even more preferred are gelatin and polyvinyl alcohol. One or more these resins may be used either singly or as combined.

In the invention, the interlayer that contain hollow particles has high cushionability, and the cushionability may de defined by “dynamic hardness”. In general, the hardness of a thin film is defined by the deformation thereof given a static load vertically applied to the surface of the film. In the invention, the dynamic hardness of the interlayer is a value measured with an ultra-micro hardness tester (Shimadzu Seisakusho's trade name, DUH-201H). Concretely, a tetrahedron having a top angle of 115° is applied to the sample under a load given thereto, and from the load and the dented depth, the dynamic hardness of the sample may be determined according to the following formula.

Dynamic Hardness DHT₁₁₅=3.7838×P/h²

In this, P means the load (mN), and h means the dented depth (μm).

This measurement method is a method for measuring the micro-motion of the needle probe as converted into an electric signal; and in this, the load may be controlled and the hardness at a desired dented depth may be determined. For measuring the dynamic hardness of the interlayer in a receiving sheet, there are two methods. In one method, the receiving layer laminated on it is previously cut off with a razor or the like and the interlayer is thereby exposed out, and in that condition, the interlayer is measured; and in the other method, the interlayer still having the receiving layer laminated thereon is measured as such. In the invention, any of these methods is employable. For example, in the method of measuring the interlayer still having the receiving layer laminated thereon, the coating thickness of the receiving layer is previously measured through observation of the enlarged photographic picture of the cross section of the layer, and the load to be applied to the sample is so determined that it gives a dented depth larger than the thickness of the receiving layer, and the hardness of the interlayer is thereby determined.

In the invention, the dynamic hardness of the interlayer is preferably at most 10.0, more preferably within a range of from 0.1 to 4.0. When the dynamic hardness is more than 10.0, then the interlayer is poorly cushionable, and if so, the receiving sheet could not be stuck to a thermal transfer sheet uniformly during printing thereon, and the quality of the formed image may be thereby worsened. On the other hand, when the dynamic hardness is extremely too small, or for example, when it is less than 0.1, then the receiving sheet may be readily scratched and its handlability may worsen.

### (Support)

In the invention, the support is preferably a water-resistant support. The water-resistant support is resistant to water penetration thereinto, and therefore the receiving layer may be prevented from being deteriorated with time. The water-resistant support is, for example, coated paper or laminated paper. In particular, laminated paper is preferred as its surface smoothness is good. Especially preferred are polyethylene-laminated paper supports and the like generally used as photographic printing paper in the filed of silver salt photographic materials, for example, cellulose-based supports coated with a polyolefin resin at least on the side thereof to be coated with a receiving layer.

### —Coated Paper—

The coated paper is produced by coating a base sheet of paper or the like with any of various resins, rubber latexes or polymer materials on one surface or both surfaces thereof. Depending on the use thereof, the coating amount varies. The coated paper includes, for example, art paper, cast-coated paper, Yankee paper, etc.

As the resin to be applied to the surface of the above-mentioned base paper or the like, a thermoplastic resin may be suitably used. Examples of the thermoplastic resin are mentioned below as (a) to (h).

(a) There are mentioned polyolefin resins such as polyethylene resin and polypropylene resin; and copolymer resins of olefins such as ethylene or propylene and other vinyl monomers; and acrylic resins, etc.
(b) Ester bond-having thermoplastic resins are mentioned. For example, these include polyester resins produced through condensation of a dicarboxylic acid component (the dicarboxylic acid component may be substituted with a sulfonic acid group, a carboxyl group or the like) and an alcohol component (the alcohol component may be substituted with a hydroxyl group or the like); polyacrylate resins and polymethacrylate resins such as polymethyl methacrylate, polybutyl methacrylate, polymethyl acrylate and polybutyl acrylate; and polycarbonate resins, polyvinyl acetate resins, styrene/acrylate resins, styrene/methacrylate copolymer resins, vinyltoluene/acrylate resins, etc.
Concretely mentioned are those described in JP-A 59-101395, 63-7971, 63-7972, 63-7973, 60-294862, etc.
Commercial products are available, including, for example, Toyobo's Vylon 290, Vylon 200, Vylon 280, Vylon 300, Vylon 103, Vylon GK-140 and Vylon GK-130; Kao's Tafton NE-382, Tafton U-5, ATR-2009 and ATR-2010; Unitika's Elitel UE3500, UE3210, XA-8153, KZA-7049 and KZA-1449; Nippon Gosei Kagaku's Polyester TP-220 and R-188; Seiko Chemical Industry's Hi-Ros series various thermoplastic resins (all trade names), etc.
(c) Polyurethane resins, etc. are mentioned.
(d) Polyamide resins, urea resins, etc. are mentioned.
(e) Polysulfone resins, etc. are mentioned.
(f) Polyvinyl chloride resins, polyvinylidene chloride resins, vinyl chloride/vinyl acetate copolymer resins, vinyl chloride/vinyl propionate copolymer resins, etc. are mentioned.
(g) Polyol resins such as polyvinyl butyral; cellulose resins such as ethyl cellulose resin, cellulose acetate resin, etc. are mentioned.
(h) Polycaprolactone resins, styrene/maleic anhydride resins, polyacrylonitrile resins, polyether resins, epoxy resins, phenolic resins, etc. are mentioned.

One or more different types of those thermoplastic resins may be used either singly or as combined.

If desired, a brightener, a conductive agent, a filler, a pigment and a dye such as titanium oxide, ultramarine or carbon black and the like may be incorporated in the thermoplastic resin.

### —Laminated Paper—

The laminated paper is produced by laminating a base sheet such as paper with any of various resin, rubber or polymer sheets or films. The laminating material includes, for example, polyolefin, polyvinyl chloride, polyethylene terephthalate, polystyrene, polymethacrylate, polycarbonate, polyimide, triacetyl cellulose, etc. One or more of these resins may be used either singly or as combined.

As the polyolefin, generally used is low-density polyethylene. For improving the heat resistance of the support, also preferred are polypropylene, polypropylene/polyethylene blend, high-density polyethylene, high-density polyethylene/low-density polyethylene blend, etc. In particular, from the viewpoint of the cost and the lamination aptitude, most preferred is high-density polyethylene/low-density polyethylene blend.

The blend ratio (by mass) of the high-density polyethylene/low-density polyethylene blend is preferably from 1/9 to 9/1, more preferably from 2/8 to 8/2, even more preferably from 3/7 to 7/3. In case where the thermoplastic resin layer is formed on both surfaces of the support, the back of the support is preferably formed by the use of, for example, high-density polyethylene or high-density polyethylene/low-density polyethylene blend. The molecular weight of polyethylene is not specifically defined. Preferably, both high-density polyethylene and low-density polyethylene have a melt index of from 1.0 to 40 g/10 min and have extrusion aptitude.

These sheets or films may be processed for imparting white reflectability thereto. For the processing, for example, employable is a method of incorporating a pigment such as titanium oxide in the sheet or the film. This is generally employed for supports for photographic printing paper in the field of silver salt photographic materials.

Preferably, the thickness of the support is from 25 μm to 300 μm, more preferably from 50 μm to 260 μm, even more preferably from 75 μm to 220 μm. The support may have a different degree of toughness depending on its use. For example, the toughness of the support for the thermal transfer image-receiving sheet having a photograph-level image quality is preferably near to that of the support for color silver salt photographic printing paper.

### (Curling Controlling Layer)

When the support is exposed out as it is, then the thermal transfer image-receiving sheet may curl depending on the humidity and the temperature in the environment; and therefore, a curling controlling layer is preferably formed on the back side of the support. The curling controlling layer not only prevents the image-receiving sheet from curling but also plays a role of waterproofness. For the curling controlling layer, usable are polyethylene lamination, polypropylene lamination, etc. Concretely, for example, the layer may be formed in the same manner as in JP-A 61-110135 and 6-202295.

### (Writing Layer, Static Charge Controlling Layer)

If desired, a writing layer and a static charge controlling layer may be provided in the thermal transfer image-receiving sheet of the invention. For the writing layer and the static charge controlling layer, usable are inorganic oxide colloids, ionic polymers, etc. As the antistatic agent for the layers, for example, usable are any of cationic antistatic agents such as quaternary ammonium salts and polyamine derivatives; anionic antistatic agents such as alkylphosphates; nonionic antistatic agents such as fatty acid esters, etc. Concretely, for example, the layers may be formed in the same manner as in Japanese Patent 3585585, etc.

### <<Method for Producing Thermal Transfer Image-Receiving Sheet>>

A method for producing the thermal transfer image-receiving sheet of the invention is described below.

The thermal transfer image-receiving sheet of the invention may be produced by forming at least one receiving layer and at least one heat-insulating layer on a support according to water-base coating.

### (Coating Liquid Preparation)

Coating liquids finally having the physical properties in accordance with the planned quality are prepared. The process comprises preparing and metering various emulsions, additives and others necessary for coating liquids, and mixing them to prepare the intended coating liquids. For the process, employable are any known system and apparatus.

For metering emulsions, additives and others, there are known a mass metering method and a volume metering method; and any of these is employable herein.

The method of preparing a coating liquid is grouped into a continuous liquid preparation system and a batchwise liquid preparation system. In producing the thermal transfer sheet and the thermal transfer image-receiving sheet in the invention, any of those methods is employable.

The continuous liquid preparation system is for a method of preparing a coating liquid, characterized in that necessary additives are added sequentially or simultaneously in a predetermined ratio to a base liquid fed at a predetermined flow rate. The advantage of the continuous liquid preparation system is that the time to be taken in preparing the coating liquid is constant and the product quality is stabilized. On the other hand, the disadvantage of the system is that the loss before the constant state is great. The system is unsuitable to the formulation that requires a long stand-by time for reaction, adsorption or the like in liquid preparation.

The batchwise liquid preparation system is a more popular method in which a dispersion and additives are stirred and mixed in a reactor or the like of a mixing device. In this system, the time for reaction and adsorption may be defined with ease, and the advantage of the system is that various measures for stirring reinforcement or preparation cycle reduction may be easy to take. On the contrary, the disadvantage of the system is that the time to be taken in preparing the coating liquid is not constant.

For the batchwise liquid preparation system, the apparatus to be used comprises a liquid preparation tank for preparing a coating liquid, a stock tank, a unit for monitoring the physical properties of the liquid being prepared, a liquid transfer pump, a filtration unit and a unit for monitoring the liquid level in the apparatus. As the liquid level meter, known are various systems of a differential pressure transmitter, an ultrasonic level meter, a tracking level meter, a road cell and the like; and any system capable of monitoring a liquid level is employable herein. The unit for monitoring the physical properties of liquid is often attached to a stock tank. In addition, the system may further has a buffer tank for feeding a coating liquid to the coating step. After the absence of abnormality of the physical properties of the liquid prepared in the stock tank has been confirmed, the liquid is then transferred to the next step. Between the prepared liquid stock tank and the buffer tank, a filter unit may be disposed. Scale change of these tanks may be possible.

In the liquid preparation tank, the materials necessary for the intended coating liquid (emulsions, various chemicals, etc.) are sequentially fed in accordance with the formation of the coating liquid to be prepared.

The liquid preparation tank may have a temperature-controllable jacket, and the chemicals to be mixed are uniformly mixed with a stirrer. The stirring blade may be any commercially-available stirring blade including, for example, propellers, paddles, jet-type blades and anchor-type blades. The stirring flow may be down flow or up flow.

The coating liquid preparation tank may be equipped with a unit for controlling the engine speed of the stirrer of the tank for attaining the same stirring and mixing efficiency in every scale of the prepared liquid, and with a baffle on the inner wall of the tank and/or around the stirring blade for the purpose of preventing the whirlpool that may occur when the liquid amount is small from reaching the stirring blade to produce foams. Equipped with these, the practical stirring region of the stirrer may be broadened.

### (Gelatin Dissolution)

In case where gelatin is added to the coating liquid, it is desirable to previously dissolve gelatin in the liquid. For dissolving gelatin, known are (1) a swelling and dissolution method comprising dispersing and dipping gelatin in water at room temperature to thereby wet entirely the powder and then heating it for dissolution, (2) a high-temperature dissolution method comprising putting gelatin in hot water and immediately heating and stirring it rapidly for dissolution, and other methods; and in the invention, any method is employable with no limitation.

### (Measurement of Physical Properties of Liquid)

For measuring the physical properties of the coating liquid, employable are various viscometers, surface tension meters, specific gravity gauges, pH meters, etc. For pH measurement, usable is a pH meter comprising a glass electrode calibrated with a pH standard buffer.

### (Coating, Liquid Feeding)

Various coating methods are known. They include dip coating, air knife coating, blade coating, regular roll coating, reversed roll coating, gravure coating, rod coating, spin coating, slot coating, curtain coating, slide coating, etc. Of those, curtain coating and slide coating are methods of determining the coating film thickness by the liquid flow rate by the use of a pump, and they enable simultaneous multi-layer coating.

In case where a multilayer-structured image-receiving sheet that has, as formed on a support, plural layers having different functions (foam layer, heat-insulating layer, interlayer, receiving layer, etc.) is produced, known are a method of forming the constitutive layers one by one as in JP-A 2004-106283, 2004-181888 and 2004-345267; and a method of laminating different units previously prepared by forming the individual layers on different supports. On the other hand, in the field of photography, for example, known is a technique of forming plural layers all at a time by simultaneous multilayer coating thereby greatly improving the producibility. For this, for example, known are a slide coating method and a curtain coating method as in U.S. Pat. Nos. 2,761,791, 2,681,234, 3,508,947, 4,475,256 and 3,993,019, JP-A 63-54975, 61-278848, 55-86557, 52-31727, 55-142565, 50-43140, 63-80872, 54-54020, 5-104061 and 5-127305, JP-B 49-7050, and Edgar B. Gutoff et al's “Coating and Drying Defects: Troubleshooting Operating Problems”, pp. 101-103, lohn Wiley & Sons (1995). According to these coating methods, plural coating liquids are fed into a coating apparatus all at a time, and plural layers are formed simultaneously. According to these methods, uniform coating thickness can be obtained and simultaneous multilayer formation is possible.

In producing the thermal transfer image-receiving sheet of the invention, any of the above-mentioned systems may be selected and employed. Preferred is a curtain coating method and a slide coating method, as producing a coating film having a uniform film thickness and as enabling simultaneous multilayer formation.

For the apparatus for slide coating, there is known a multilayer slide-bead apparatus as proposed by Russell et al. in U.S. Pat. No. 2,761,791. In this apparatus, beads are formed in the distance in which plural coating liquids that run down on a slide surface meet a continuously running support at the end of the slide surface, and via the beads, the coating liquids are applied to the surface of the support. Accordingly in this apparatus, it is important to stably form the beads. Examples of the slide coater are described in Stephen F. Kistler and Peter M. Schweizer's “LIQUID FILM COATING” by CHAPMAN & HALL (1997).

The curtain coating is a method of coating a support that runs at a constant speed below a liquid film that freely drops down onto it. This includes various systems of extrusion coating, slide coating or the like. In the slide coater, a multilayer liquid film formed on the slide surface freely drops sown from the slide edge. Accordingly, the shape of the slide edge is specifically so planned that the dropping liquid film can be smoothly formed at that edge.

### <Liquid Feeding>

The coating liquid prepared to have suitable physical data of liquid concentration, viscosity, surface tension and pH must be continuously fed to the coating zone, while removing foams and impurities from it.

For continuously feeding the coating liquid at a constant flow rate, various methods may be taken. From the viewpoint of the accuracy and the reliability, preferred is a metering pump. Examples of the pump are a plunger pump, and a diaphragm pump. In the diaphragm pump, the plunger and the liquid to be fed are partitioned by two diaphragms, and via a driving oil and pure water between two diaphragms, the motion of the plunger is transmitted to the liquid to be fed. The flow rate change of the liquid-feeding pump is linked to the coating film thickness change, and therefore it requires high accuracy.

In case where the pulsation of pump must be reduced, an auxiliary unit for pulsation absorption may be used. Some known units are known; and one example is a pipeline pulsation absorber (JP-A 1-255793).

For removing impurities, preferably, the coating liquid is filtered. Various types of filters may be used. One example is a cartridge filter. Before use, it is preferably pre-treated for preventing the air held in the pores in the filter from penetrating into the coating liquid as foams therein. Some methods are known. One example is pretreating the filter with a surfactant-containing liquid or the like (U.S. Pat. No. 5,096,602).

In addition to impurities, bubbles also cause failures of the coating surface. Accordingly, it is desirable to remove and defoam the bubbles floating in the liquid surface. For this, known are a method of removing bubbles from the liquid, and a method of dissolving bubbles in the liquid. As the removing method, known are defoaming under reduced pressure, ultrasonic defoaming and centrifugal defoaming. As the dissolving method, known is ultrasonic pipeline defoaming.

In case where additives that may worsen the storage stability of the coating liquid to which they are added are added thereto, known is a method of adding them just before the coating zone in the liquid-feeding system for shortening the standby time of the liquid after addition to coating. In the invention, the method is also employable. The mixer usable in the method includes a static mixer and a dynamic mixer.

### <Slide Coating>

The slide-bead coating apparatus mainly comprises a coating head and a backup roller to carry and support the support continuously running around it. Inside the block to constitute the coating head, formed is a liquid pool in which the coating liquid fed thereinto from the liquid-feeding line is expanded in the cross direction of the support, and as communicating with the liquid pool, a narrow slid is opened to run to the slide surface. The slide surface is formed on the upper surface of the coating head, and is inclined downward toward the backup roller side.

The coating liquids thus fed to the respective liquid pools are extruded out onto the slide surface through the respective slits, and while running down on the slide surface, they sequentially form plural layers to be a multilayer coating film, and not mixing together, they reach the top end of the lower edge of the slide surface. The coating liquids thus having reached the top end form coating liquid beads in the space between the top end and the surface of the support running while carried and supported by the backup roller, and via the coating liquid beads, they are applied onto the support surface. For stabilizing the beads, the pressure in the lower part is reduced. Accordingly, a degassing chamber is formed downstream the backup roller. The degassing chamber makes the lower side of the beads have negative pressure to thereby stabilize the beads, and the superfluous coating liquid not applied to the support to form a web thereon is led to readily flow down toward the degassing chamber.

At the start of the coating, layer flows are formed on the slide surface, and in that condition, the coating head is moved from the standby position to the support side whereby the gap between the coating head and the support is made to have a suitable size.

For coating with a large amount a coating liquid, a bonded support may be used. Since the gap between the coating head and the support is narrow, the beads may be disordered by a slight step difference at the bonded part, and it may cause coating failures. To solve the problem, employable are a method of roughening the part just after the bonded part (JP-A 50-43140), or method of providing a minor Giesser tool (JP-A 63-80872).

### <Curtain Coating>

The curtain coating method is grouped into an extrusion coating method and a slide coating method. In the extrusion coating method, the coating liquid fed into the liquid poor via a feeding pump is extruded out uniformly in the coating width direction through a narrow slit. At both ends of the slit outlet, provided is an edge guide, and between these, a curtain-like liquid film is formed. The liquid film drops down by its own weight and colloids against the support continuously running below it, thereby forming a coating layer on the support.

In the slide coating method, a coating head like that in the slide-bead coating system is used. The coating liquid fed into the liquid pool of the coater via a pump is jetted out through a narrow slit, then this drops down on the slide surface, and forms a curtain-like liquid film between the edge guides provided at both ends of the lower side. In simultaneously multilayer coating, the individual coating liquids do not mix together while running down on the slide surface, and they are thereafter laminated to form a multilayer liquid film. The slide surface is inclined, and the coating liquids flow down on the slide surface by their own gravity.

Some methods are known for initiating and stopping the coating. For example, there is known a method of disposing a barrier substance between the formed curtain-like film and the support. By removing the barrier substance, the coating is initiated, and by again disposing it at the original position, the coating is stopped.

### (Drying)

After thus coated, the support is led to pass through a setting zone (only in the case of cooling and solidifying the coating film), a drying zone, a moisture-conditioning zone and a winding zone, and the thus-wound coated product is once stored.

The coating liquid to which a known gelling agent such as gelatin, pectin, agar, carrageenan, gellan gum or the like is added is cooled, gelled and solidified in the setting zone. In this stage, the moisture is also evaporated away.

In the invention, it is desirable that a laminate of plural layers is formed on a support and then immediately cooled and solidified (setting step), and thereafter this is heated and dried. According to the method, a more uniform and homogeneous coating film may be formed. When the coating film is exposed to strong dry air while it is not as yet sufficiently solidified, then it may flow and may be uneven. When an organic solvent remains in the outermost layer of the coating film, then the solvent may unevenly evaporate away by air applied thereto on the slide surface or immediately after coating, thereby forming an uneven coating film. From this viewpoint, water-base coating is advantageous.

The setting process means a gellation promoting process in which the viscosity of the coating film composition is increased by applying cold water or the like to the coating film to cool the film whereby the fluidity of the constitutive layers and the substance fluidity in those layers are reduced.

The temperature condition of the cold air to be employed herein is preferably not higher than 25° C., more preferably not higher than 10° C.

In the drying zone, the coating film is dried after a constant drying rate period in which the drying speed is constant and the material temperature and the wet-bulb temperature are the same, and after a decreasing drying rate period in which the drying speed decreases and the material temperature rises. In the constant drying rate period, all the external heat applied to the coating film is consumed for moisture evaporation. In the decreasing drying rate period, the moisture diffusion rate inside the material is determined, and the evaporation surface is reduced whereby the drying speed is lowered, and the heat given to the coating film may be consumed for material temperature elevation.

In the setting zone and the drying zone, moisture movement occurs between the coating layers and between the support and the coating layers, and the coating film is thereby cooled and solidified by moisture evaporation. Accordingly, the quality and the property of the products are greatly influenced by the history of the film surface temperature and the drying time during the drying process, and therefore the drying conditions are desired to be suitably planned in accordance with the necessary quality and properties of the final products. In the invention, the main ingredient of the coating liquid is a latex, and therefore, when the coating film is rapidly dried, then the film may be unevenly shrunk by the rapid drying and the dried coating film may be often cracked. Accordingly, in the invention, a slow drying method is preferred.

Thus dried, the coated product is further processed to have a predetermined moisture content and then wound up. However, depending on the water content and the temperature of the wound product during its storage, the degree of film hardening varies; and therefore, regarding the water content of the product being wound up, the product requires a condition of suitable moisture control.

In general, the film hardening goes on more rapidly at higher temperature and higher humidity. However, when the water content is too large, the coated products may stick together, therefore causing a problem of quality reduction. Accordingly, the condition of the water content of the film being wound (moisture control) and the condition of the storage of the wound film must be suitably controlled in accordance with the intended quality of the product.

### <Drying Apparatus>

Typical drying apparatuses are an air-loop system and a helical system. The air-loop system is for jetting a dry air jet toward the coated product supported by a roller, in which the duct may be a vertical duct or a horizontal duct. In this, the drying function and the conveying function are basically separated, and the latitude in the flow rate and others is large. In this system, a large number of rollers are used, and therefore the base conveyance failures such as shifting, wrinkling or slipping may occur. In the helical system, the coated product is helically hung in a cylindrical duct and while this is floated up with dry air (air floating), this is conveyed and dried. Basically, this does not require supporting with a roller (JP-B 43-20438). Apart from these, also known is a drying system where ducts are alternately disposed in the upper and lower portions. In general, the drying distribution in this system is better than that in the helical system, but the floating capability is inferior to that in the latter.

### (Working)

Thus coated and dried, the thermal transfer image-receiving sheet must be worked into the shape suitable to use in printer. The product form of the thermal transfer image-receiving sheet is grouped into a sheet-cut image-receiving sheet and a roll-form image-receiving sheet. The roll-form image-receiving sheet has no problem of double feeding in printer, and in this sheet, a printing area may be selected within a predetermined range.

The coating width in the production apparatus is generally larger than the sheet width needed in printer, and therefore, the coated product of the image-receiving sheet is led into a slitter and must be slit into a smaller width in the machine direction of the coated product. For the slitting method for this, any system may be suitably selected from known methods. Examples of the method include a share cutting system, a laser cutting system, a score cutting system, etc. The share cutting system is for cutting the film by the engaging portion of the upper and lower cutting edges that are rotating; the laser cutting system is for cutting the film by one cutting edge alone, and this includes an air cutting system and a grooving system. The score cutting system is for cutting the film by pressing an upper cutting edge against a lower cutting edge. Regarding the material of the cutting edge, any one may be suitably selected from known materials.

For sheet-cut image-receiving sheets, the image-receiving sheet roll that has been slit to a desired width is cut into a predetermined length, and a necessary number of the cut sheets are piled up. By the slit width and the cut length, the maximum print area of the sheet-cut product is defined.

The roll-form image-receiving sheet is produced by winding up the thermal transfer image-receiving sheet slit to have a length in accordance with printer, around a cylinder, and then cut to give a small roll of the sheet. The material of the winding up cylinder may be any of paper, plastic, metal, wood or their composite. From the viewpoint of the winding habit, preferred is a winding cylinder having a large cylinder outer diameter. However, when the outer diameter is too large, then the outer diameter of the roll-form image-receiving sheet may also be large, and this requires a large space in printer for housing it. The winding cylinder is used generally, but it may not be used. The image-receiving layer side may be outside or inside the roll.

There are many known cutting systems, for example, a cutting system of intermittently feeding an object to be cut and cutting it when it has stopped; a cutting system where the cutter moves back and forth relative to the traveling direction of the object to be cut and when the speed of the two has become the same, the object is cut. Of the known systems, any one can be selected and used herein.

A pile of sheet-cut image-receiving sheets and a small unit of a roll-form image-receiving sheet are, in general, separately packaged with a moisture-proof packing material. The temperature and humidity condition in the working process of slitting or unit-winding and in the packaging process may have significant influences on the crosslinking of the binder in the coating layer, therefore controlling the curling condition of the image-receiving sheet.

Curling of the thermal transfer image-receiving sheet is a significant cause of troubles in printing and paper feeding in printer. For example, when the unprinted image-receiving sheet is much curled, then it may be caught by the feeding roll and the guide in a printer, therefore causing feeing troubles. In addition, the curled sheet is poorly compatible with printer. In printing, the curled sheet has some negative influence on the fittability with a thermal head, therefore often causing surface condition failures. In view of these, the temperature and humidity condition in the working and packaging process must be carefully determined.

The thermal transfer sheet that is used along with the thermal transfer image-receiving sheet of the invention in thermal transfer image formation on the image-receiving sheet comprises a dye layer containing a diffusion transfer dye; and any thermal transfer sheet may be used in the invention. In the image formation method of the invention, the thermal transfer image-receiving sheet of the invention is attached to a thermal transfer sheet in such a manner that the receiving sheet of the former may be in contact with the thermal transfer layer of the latter. Any known conventional method may be employed for imparting thermal energy to the combined sheets in thermal image transfer from the former to the latter. For example, using a recording apparatus such as a thermal printer (e.g., FUJIFILM's ASK-2000), thermal energy of from 0 to 50 mJ/mm² or so may be applied to the combined sheets in accordance with the image signal with controlling the recording time and the thermal head temperature, whereby the intended object can be fully attained.

Concretely, for example, the image formation may be attained in the same manner as in JP-A 2005-88545.

By suitably selecting the support to be used therein, the thermal transfer image-receiving sheet of the invention may be applied to thermal transfer recordable sheet-cut or roll-formed thermal transfer image-receiving sheets, cards, sheets for formation of transparent original images, and other applications; and it can be used in thermal transfer recording-type printers, duplicators, etc.

### EXAMPLES

The characteristics of the invention are described more concretely with reference to Examples and Comparative Examples given hereinunder. In the following Examples, the material used, its amount and the ratio, the details of the treatment and the treatment process may be suitably modified or changed not overstepping the spirit and the scope of the invention. Accordingly, the invention should not be limitatively interpreted by the Examples mentioned below. In the Examples, parts and % are all by mass, unless otherwise specifically indicated.

### Example 1

### Production of Hollow Particles A

### <Production of Seed Particles>

A monomer liquid comprising 83 g of butyl acrylate, 75 g of methyl methacrylate and 2 g of methacrylic acid was prepared.

560 g of distilled water and sodium dodecylbenzenesulfonate (Kao's trade name, Neopelex G-15) were put into a reactor equipped with a stirrer and a reflux condenser, and heated at 80° C. in a nitrogen atmosphere. 0.6 g of APS (ammonium peroxodisulfate, by Wako Pure Chemicals (dissolved in 60 g of distilled water, and 6% of the whole amount of the monomer liquid (9 g) were added thereto, and stirred in a nitrogen atmosphere at 80° C. for 15 minutes. Next, the contents of the reactor were heated up to 85° C., and the residual monomer liquid was dropwise added thereto, taking 1 hour. After the addition, this was stirred at 85° C. for 1 hour, and the reaction was thus completed to give a seed latex S1. The solid content of the obtained seed latex was 20.5%, and the mass-average molecular weight thereof was 3.6×10⁵. The mean particle size of the polymer particles was 100 nm.

### <Production of Core Particles>

A monomer liquid comprising 98 g of methyl methacrylate, 42 g of methacrylic acid and 0.7 g of ethylene glycol dimethacrylate was prepared.

400 g of distilled water was put into a reactor equipped with a stirrer and reflux condenser, heated in a nitrogen atmosphere at 85° C., and 0.84 g of SPS (sodium peroxodisulfate, by Wako Pure Chemicals) dissolved in 30 g of distilled water and 12.4 g of the seed latex S1 were added to it. Next, the monomer liquid was dropwise added thereto, taking 3 hours, and after the addition, this was heated and stirred for 30 minutes to complete the polymerization, thereby giving a core latex C1. The solid content of the obtained core latex was 23.0%, and the mass-average molecular weight thereof was 0.8×10⁵. The mean particle size of the polymer particles was 336.9 nm.

### <Production of Core/Shell Particles>

### Monomer Liquid for Interlayer:

A monomer liquid A comprising 89.92 g of styrene, 38.49 g of 2-ethylhexyl acrylate and 1.3 g of ethylene glycol diacrylate was prepared.

### Monomer Liquid for Outer Layer:

A monomer liquid B of 32.4 g of styrene was prepared.

660 g of distilled water was put into a reactor equipped with a stirrer and a reflux condenser, and heated at 80° C. in a nitrogen atmosphere, and 0.63 g of SPS (sodium peroxodisulfate, by Wako Pure Chemicals) dissolved in 60 g of distilled water and 13 g of the core latex C1 were added thereto. First, the monomer liquid A was dropwise added to it, taking 0.8 hours. After the addition, this was stirred at 80° C. for 1 hour, thereby completing interlayer formation. Next, the monomer B was added to it, taking 0.2 hours. After the addition, this was stirred at 80° C. for 0.5 hours, thereby completing outer layer formation.

During the process, the reaction liquid was sampled from the reactor, and the particle size measured. The mean particle size after the step of interlayer formation was 671.2 nm, and the mean particle size after outer layer formation was 711.1 nm.

### <Osmotic Pressure Swelling Step>

The shell formation step was followed by an osmotic pressure swelling step. After the outer layer formation, the contents of the reactor were heated up to 85° C. 100 ml of aqueous 2.8% ammonia was added to it, and stirred at 85° C. for 1 hour to complete the swelling of the particles. After swollen, the mean particle size of the hollow particles A was 915.5 nm, and the solid content thereof was 16.5%.

### Example 2

### Production of Hollow Particles B

Hollow particles B were produced in the same manner as in Example 1, for which, however, the monomer and the mass ratio of each layer were changed as in Table 1 below.

### Example 3

### Production of Hollow Particles C

Hollow particles C were produced in the same manner as in Example 1, for which, however, the monomer and the mass ratio of each layer were changed as in Table 1 below.

### Comparative Example 1

### Production of Hollow Particles D

Hollow particles D were produced according to Example 1 in JP-A 10-110018.

### Comparative Example 2

### Production of Hollow Particles E

Hollow particles E were produced according to Example 1 in WO98/39372.

### Test Example 1

### Analysis and Evaluation of Hollow Particles

### (Evaluation in Hollow Formation)

The hollow particles A to E were evaluated in point of hollow formation, according to the following standards:

A: Unswollen particles, dented particles and broken particles were not almost seen.
B: Some unswollen particles, dented particles and broken particles existed.
C: Many unswollen particles, dented particles and broken particles existed.

### <Measurement of Minimum Film Formation Temperature (MFT)>

Using a film formation temperature meter (Yoshimitsu Instruments' MFT-1), the minimum film formation temperature (MFT) of each hollow particle latex (solid content 15%) was measured according to the above-mentioned method.

### <Measurement of Dynamic Hardness of Single Film>

The hollow particle latex was mixed with a binder, gelatin in an amount of 30% by mass of the overall solid content, thereby preparing a coating liquid. Using a doctor coater, this was applied onto a glass substrate and dried to form a coating film (a sample of single film) having a thickness of 100 μm. Using an ultra-micro hardness tester (Shimadzu Seisakusho's trade name, DUH-201H), the dynamic hardness of the film sample was measured according to the above-mentioned method.

The characteristic data of the hollow particles are shown in Table 1.

TABLE 1

| | | | | | Comparative | Comparative |
|---|---|---|---|---|---|---|
| | | Example 1 | Example 2 | Example 3 | Example 1 | Example 2 |
| | | Hollow | Hollow | Hollow | Hollow | Hollow |
| | | Particles A | Particles B | Particles C | Particles D | Particles E |
| Core | amount (part) | 5.2 | 5.2 | 5.2 | 6 | 14 |
| Polymer | MMA (%) | 69.7 | 69.7 | 69.7 | 55 | 70.3 |
| | MAA (%) | 30.7 | 30.7 | 30.7 | 40 | 29.1 |
| | EGDMA (%) | 0.5 | 0.5 | 0.5 | — | 0.6 |
| | particle size | 336.9 | 336.9 | 336.9 | 163 | 130 |
| Inter- | amount (part) | 75.8 | 84.3 | 58.3 | 25 | 43 |
| layer | St (%) | 69.5 | — | — | — | — |
| Polymer | MMA (%) | — | 84.5 | 65.5 | 78 | 77.2 |
| | BA (%) | — | — | 33.5 | 22 | 18.1 |
| | 2EHA (%) | 29.5 | 15.0 | — | — | — |
| | MAA (%) | — | — | — | — | 4.56 |
| | EGDMA (%) | 1.0 | 0.5 | 1.0 | — | 0.17 |
| | Tg (° C.) | 57.1 | 70.3 | 45.1 | 53 | 56 |
| | particle size | 671.2 | 720.5 | 603.5 | 220 | 263 |
| Outer | amount (part) | 18.9 | 10.5 | 36.5 | 65 | 43 |
| Layer | St (%) | 100 | 99 | 99 | 100 | 73.5 |
| Polymer | MMA (%) | — | — | — | — | 24.8 |
| | DVB (%) | — | 1.0 | — | — | 1.7 |
| | EGDMA (%) | — | — | 1.0 | — | — |
| | Tg (° C.) | 105 | 110 | 108 | 105 | 110 |
| | particle size | 711.1 | 760.3 | 693.5 | 450 | 300 |
| Characteristics | particle size | 915.5 | 890.2 | 1002.3 | 500 | 370 |
| of Hollow | hollow | A | A | A | B | B |
| Particles | formation | | | | | |
| | MFT (° C.) | 85 | 93 | 90 | 80 | 79 |
| | dynamic | 7.3 | 10.5 | 9.6 | 18.2 | 15.1 |
| | hardness | | | | | |
| | (single film) | | | | | |

MMA: methyl methacrylate,
MAA: methacrylic acid,
EGDMA: ethylene glycol dimethacrylate,
St: styrene,
BA: butyl acrylate,
2EHA: 2-ethylhexyl acrylate,
DVB: divinylbenzene,
Tg: glass transition temperature,
MFT: minimum film formation temperature

### Example 4

### Production of Thermal Transfer Image-Receiving Sheet A

### (Preparation of Support for Thermal Transfer Image-Receiving Sheet)

50 parts by mass of LBKP (hardwood bleached kraft pulp) of acacia and 50 parts by mass of LBKP of aspen were refined with a disc refiner into a Canadian freeness of 300 ml, thereby preparing a pulp slurry.

Next, to the pulp slurry obtained in the above, added were cation-modified starch (Nippon NSC's trade name, CAT0304L) in an amount of 1.3% of the pulp, anionic polyacrylamide (Seiko PMC's trade name DA4104) in an amount of 0.15%, alkylketene dimer (Arakawa Chemical's trade name, Sizepine K) in an amount of 0.29%, epoxydated benenic amide in an amount of 0.29% and polyamide-polyamine epichlorohydrin (Arakawa Chemical s trade name, Arafix 100) in an amount of 0.32%, and then a defoaming agent was added thereto in an amount of 0.12%.

The pulp slurry prepared in the manner as above was sheeted, using a Fourdrinier paper machine, and the formed web was dried by pressing its felt surface against a drum drier cylinder via the drier canvas. In the drying step, the tension of the drier canvas was set at 1.6 kg/cm. Next, using a size press, polyvinyl alcohol (Kuraray's trade name, LK-118) was applied onto both surfaces of the sheet thus produced, in an amount of 1 g/m², and dried, and then calendered. The unit weight of the uncoated sheet was 157 g/m². The thickness of the coated sheet (substrate) was 160 μm.

The wire face (back) of the thus-prepared substrate was processed for corona discharge treatment. Next, using a melt extruder, a resin composition prepared by mixing high-density polyethylene having MFR (melt flow rate—the same shall apply hereinunder) of 16.0 g/10 min and a density of 0.96 g/cm³ (containing 250 ppm of hydrotalcite (Kyowa Chemical Industry's trade name, DHT-4A), and 200 ppm of secondary antioxidant (tris(2,4-di-tert-butylphenyl) phosphite, Ciba Specialty Chemicals' trade name Irgafos 168)), and low-density polyethylene having MFR of 4.0 g/10 min and a density of 0.93 g/cm³ in a ration of 75/25 (by mass) was applied onto the substrate to form a coating layer having a thickness of 21 g/m², thereby forming a mat face-having thermoplastic resin layer (the thermoplastic resin layer face is hereinafter referred to as “back”). The thermoplastic resin layer of the back of the substrate was processed for corona discharge treatment, and thereafter as an antistatic agent, a dispersion prepared by dispersing aluminium oxide (Nissan Chemical Industry's trade name, Alumina Sol 100) and silicon dioxide (Nissan Chemical Industry's trade name, Snow tex O) in a ratio of 1/2 by mass, in water was applied to it in an amount, as a dry mass, of 0.2 g/m². Next, the surface of the substrate was corona-treated, and low-density polyethylene having MFR of 4.0 g/10 min and a density of 0.93 g/m² and containing 10% by mass of titanium oxide was applied in an amount of 27 g/m² onto the surface of the substrate, using a melt extruder, thereby forming a mirror face-having thermoplastic resin layer.

### (Production of Thermal Transfer Image-Receiving Sheet)

The surface of a paper support laminated with polyethylene on both surfaces thereof was processed for corona discharge treatment, and then a gelatin undercoat layer containing sodium dodecylbenzenesulfonate was formed. This was laminated with the coating liquid for undercoat layer, the coating liquid for heat-insulating layer and the coating liquid for receiving layer all mentioned below, in that order according to the simultaneous multilayer formation method illustrated in FIG. 9 in U.S. Pat. No. 2,761,791. The coating was so controlled that the dry coating amount of the undercoat layer could be 6.3 g/m², that of the heat-insulating layer could be 10.7 g/m², and that of the receiving layer could be 5.0 g/m². After dried, a thermal transfer image-receiving sheet A was obtained.

The compositions of the constitutive layers are shown below, in which the amount of the ingredient is in terms of the solid content as part by mass.

### Coating Liquid for Undercoat Layer:

| | |
|---|---|
| Polyvinyl alcohol (Poval PVA205, trade name | 8.7 mas. pts. |
| by Kuraray) | |
| Styrene/butadiene rubber latex (SN-307, trade name by | 58.0 mas. pts. |
| Nippon A&L) | |
| Surfactant F-1 mentioned below | 0.03 mas. pts. |

### Coating Liquid for Heat-Insulating Layer:

| | |
|---|---|
| Hollow particles A of the invention | 60.0 mas. pts. |
| Gelatin (aqueous 10% solution) | 30.0 mas. pts. |

### Coating Liquid for Receiving Layer:

| | | |
|---|---|---|
| Vinyl chloride-base latex (Vinybran 690, | 50.0 | mas. pts. |
| trade name by Nisshin | | |
| Chemical Industry) | | |
| Gelatin | 0.5 | mas. pts. |
| Ester-base wax EW-1 mentioned below | 2.0 | mas. pts. |
| Surfactant F-1 mentioned below | 0.11 | mas. pts. |
| Surfactant F-2 mentioned below | 0.36 | mas. pts. |

EW-1

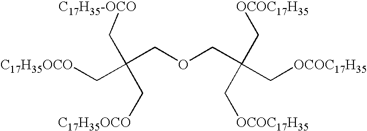

F-1

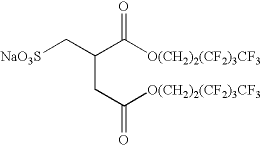

F-2

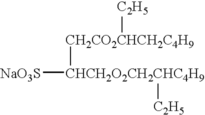

### Example 5

### Production of Thermal Transfer Image-Receiving Sheet B

A thermal transfer image-receiving sheet B was produced in the same manner as in Example 4, for which, however, the same % by mass of the hollow particles B were used in place of the hollow particles A in Example 4.

### Example 6

### Production of Thermal Transfer Image-Receiving Sheet C

A thermal transfer image-receiving sheet C was produced in the same manner as in Example 4, for which, however, the same % by mass of the hollow particles C were used in place of the hollow particles A in Example 4.

### Comparative Example 3

### Production of Thermal Transfer Image-Receiving Sheet D

A thermal transfer image-receiving sheet D was produced in the same manner as in Example 4, for which, however, the same % by mass of the hollow particles D were used in place of the hollow particles A in Example 4.

### Comparative Example 4

### Production of Thermal Transfer Image-Receiving Sheet E

A thermal transfer image-receiving sheet E was produced in the same manner as in Example 4, for which, however, the same % by mass of the hollow particles E were used in place of the hollow particles A in Example 4.

### Comparative Example 5

### Production of Thermal Transfer Image-Receiving Sheet F

A thermal transfer image-receiving sheet F was produced in the same manner as in Example 4, for which, however, the same % by mass of MH-5055 (by Nippon Zeon) was used in place of the hollow particles A in Example 4.

### Test Example 2

### Evaluation of Thermal Transfer Image-Receiving Sheet

### (Formation of Thermal Transfer Sheet)

As a support, prepared was a polyester film having a thickness of 6.0 μm (Daiafoil 200E-6F, trade name by Mitsubishi Polyester Film), of which one surface had been processed for adhesion enhancement. On the other surface of the film not processed for adhesion enhancement, the coating liquid for back layer mentioned below was applied in a dry coating amount, as the solid content, of 1 g/m². After dried, this was cured through heat treatment at 60° C.

The coating liquids for yellow, magenta and cyan thermal transfer layers and the coating liquid for transferable protective layer laminate all mentioned below were applied in order onto the adhesion enhancement-processed surface of the thus-prepared polyester film, and then dried to produce a thermal transfer sheet. The solid coating amount of each dye layer was 0.8 g/m². The transferable protective layer laminate was formed as follows: The coating liquid for release layer was applied and dried, and thereafter the coating liquid for protective layer was applied onto it and dried, and finally the coating liquid for adhesive layer was applied thereon and dried. The dry coating amount of the release layer was 0.3 g/m²; that of the protective layer was 0.5 g/m²; and that of the adhesive layer was 2.2 g/m².

### Coating Liquid for Back Layer:

| | |
|---|---|
| Acrylic polyol resin (Acrydic A-801, trade name by | 26.0 mas. pts. |
| Dai-Nippon Ink Chemical Industry) | |
| Zinc stearate (SZ-2000, trade name by Sakai | 0.43 mas. pts. |
| Chemical Industry) | |
| Phosphate (Prisurf A217, trade name by Daiichi | 1.27 mas. pts. |
| Kogyo Seiyaku) | |
| Isocyanate (50% solution) (Vernock D-800, trade name | 8.0 mas. pts. |
| by Dai-Nippon Ink Chemical Industry) | |
| Methyl ethyl ketone/toluene (2/1 by mass) | 64 mas. pts. |

### Coating Liquid for Yellow Dye Layer:

| | | |
|---|---|---|
| Dye compound (Y-1) | 3.9 | mas. pts. |
| Dye compound (Y-2) | 3.9 | mas. pts. |
| Polyvinyl acetal resin | 6.1 | mas. pts. |
| (Eslec KS-1, trade name by | | |
| Sekisui Chemical) | | |
| Polyvinyl butyral resin | 2.1 | mas. pts. |
| (Denka Butyral #6000-C, trade | | |
| name by Denki Kagaku Kogyo) | | |
| Release agent (X-22-3000T, trade | 0.05 | mas. pts. |
| name by Shin-etch Chemical | | |
| Industry) | | |
| Release agent (TSF4701, trade name | 0.03 | mas. pts. |
| by Momentive Performance | | |
| Materials Japan) | | |
| Mat agent (FLO-THEME UF, trade name | 0.15 | mas. pts. |
| by Sumitomo Seika) | | |
| Methyl ethyl ketone/toluene | 84 | mas. pts. |
| (2/1 by mass) | | |

Y-1:

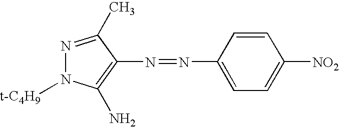

Y-2:

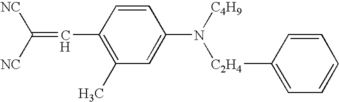

### Coating Liquid for Magenta Dye Layer:

| | | |
|---|---|---|
| Dye compound (M-1) | 0.1 | mas. pts. |
| Dye compound (M-2) | 0.7 | mas. pts. |
| Dye compound (M-3) | 6.6 | mas. pts. |
| Polyvinylacetal resin | 8.0 | mas. pts. |
| (Eslec KS-1, trade name | | |
| by Sekisui Chemical Industry) | | |
| Polyvinyl butyral resin | 0.2 | mas. pts. |
| (Denka Butyral #6000-C, trade | | |
| name by Denki Kagaku Kogyo) | | |
| Release agent (X-22-3000T, trade | 0.05 | mas. pts. |
| name by Shin-etch Chemical | | |
| Industry) | | |
| Release agent (TSF4701, trade name | 0.03 | mas. pts. |
| by Momentive Performance | | |
| Materials Japan) | | |
| Mat agent (FLO-THEME UF, trade name | 0.15 | mas. pts. |
| by Sumitomo Seika) | | |
| Methyl ethyl ketone/toluene | 84 | mas. pts. |
| (2/1 by mass) | | |

M-1:

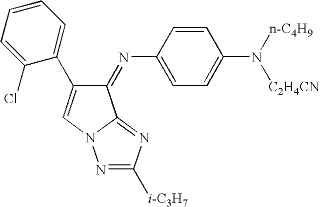

M-2:

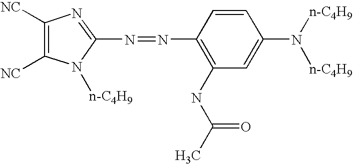

M-3:

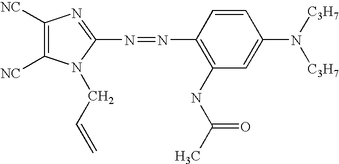

### Coating Liquid for Cyan Dye Layer:

| | | |
|---|---|---|
| Dye compound (C-1) | 1.2 | mas. pts. |
| Dye compound (C-2) | 6.6 | mas. pts. |
| Polyvinyl acetal resin | 7.4 | mas. pts. |
| (Eslec KS-1, trade name by | | |
| Sekisui Chemical Industry) | | |
| Polyvinyl butyral resin (Denka | 0.8 | mas. pts. |
| Butyral #6000-C, trade name | | |
| by Denki Kagaku Kogyo) | | |
| Release agent (X-22-3000T, trade | 0.05 | mas. pts. |
| name by Shin-etch Chemical | | |
| Industry) | | |
| Release agent (TSF4701, trade name | 0.03 | mas. pts. |
| by Momentive Performance | | |
| Materials Japan) | | |
| Mat agent (FLO-THEME UF, trade name | 0.15 | mas. pts. |
| by Sumitomo Seika) | | |
| Methyl ethyl ketone/toluene (2/1 by mass) | 84 | mas. pts. |

C-1:

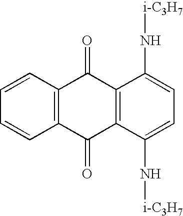

C-2:

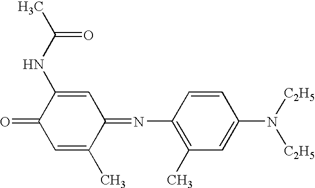

### Coating Liquid for Release Layer:

| | |
|---|---|
| Modified cellulose resin (L-30, by Daicel Chemical) | 5.0 mas. pts. |
| Methyl ethyl ketone | 95.0 mas. pts. |

### Coating Liquid for Protective Layer:

| | |
|---|---|
| Acrylic resin solution (solid content 40%) (UNO-1, trade | 90 mas. pts. |
| name by Gifu Ceramic) | |
| Methanol/isopropanol (1/1 by mass) | 10 mas. pts. |

### Coating Liquid for Adhesive Layer:

| | | |
|---|---|---|
| Acrylic resin (Dianal BR-77, trade name | 25 | mas. pts. |
| by Mitsubishi Rayon) | | |
| UV absorbent UV-1 | 1 | mas. pt. |
| UV absorbent UV-2 | 2 | mas. pts. |
| UV absorbent UV-3 | 1 | mas. pt. |
| UV absorbent UV-4 | 1 | mas. pt. |
| PMMA fine particles | 0.4 | mas. pts. |
| (polymethyl methacrylate | | |
| fine particles) | | |
| Methyl ethyl ketone/toluene | 70 | mas. pts. |
| (2/1 by mass) | | |

UV-1

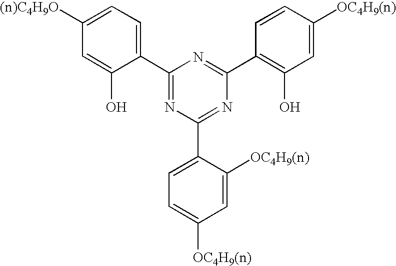

UV-2

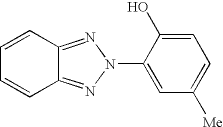

UV-3

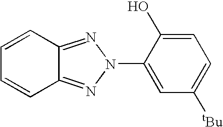

UV-4

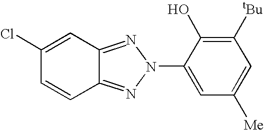

### (Measurement of Dynamic Hardness of Heat-Insulating Layer)

The dynamic hardness of the thermal transfer image-receiving sheets A to F was measured with an ultra-micro hardness tester (Shimadzu Seisakusho's trade name, DUH-201H), according to the above-mentioned method.

### (Measurement of Maximum Transfer Density)

The thermal transfer image-receiving sheets A to F were separately combined with the above-mentioned thermal transfer sheet and tested for black solid image (maximum density image) formation thereon, using a thermal transfer printer (FUJIFILM's ASK-2000). Using a densitometer (X-Rite), the cyan density of the image transferred on the thermal transfer image-receiving sheet was measured.

### (Evaluation of Density Evenness)

The thermal transfer image-receiving sheets A to F were separately combined with the above-mentioned thermal transfer sheet and tested for image formation thereon of a black image having an optical density of 0.3, at 23° C. and 50% RH, using the thermal transfer printer (FUJIFILM's ASK-2000). The image transferred on the thermal transfer image-receiving sheet was visually checked for density unevenness according to the following standards. Samples on the rank A are acceptable for practical use.

A: Excellent with no density unevenness.

B: Some density unevenness.

C: Much density unevenness.

### (Results)

The results of the above measurement and evaluation are shown in Table 2.

TABLE 2

| | | |
|---|---|---|
| Dynamic Hardness | Maximum | |
| (heat-insulating | Transfer | Density |
| layer) | Density | Evenness |

| | | | |
|---|---|---|---|
| Example 4 | 1.3 | 2.31 | A |
| (image-receiving | | | |
| sheet A) | | | |
| Example 5 | 3.9 | 2.35 | A |
| (image-receiving | | | |
| sheet B) | | | |
| Example 6 | 2.6 | 2.29 | A |
| (image-receiving | | | |
| sheet C) | | | |
| Comparative Example 3 | 14.6 | 1.90 | B |
| (image-receiving | | | |
| sheet D) | | | |
| Comparative Example 4 | 11.1 | 2.05 | B |
| (image-receiving | | | |
| sheet E) | | | |
| Comparative Example 5 | 21.0 | 2.15 | C |
| (image-receiving | | | |
| sheet F) | | | |

The invention provides hollow particles capable of forming a coating film excellent in flexibility and heat resistance and having a hollow morphology, provides a method for producing them. Using the hollow particles, the invention provides a thermal transfer image-receiving sheet which has a high maximum transfer density and has few image failures such as density unevenness and pin holes. Accordingly, the industrial applicability of the invention is good.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 250658/2007 filed on Sep. 27, 2007, which is expressly incorporated herein by reference in its entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A hollow particle having a core/shell structure in which
the core contains an acid group and is crosslinked,
the surface of the core is covered with an interlayer of an acid group-free, crosslinked resin having a glass transition temperature (Tg) of from −60° C. to 80° C.,
the surface of the interlayer is covered with an outer layer of an acid group-free, crosslinked resin having a glass transition temperature (Tg) of from 80 to 150° C., and
the particle has a hollow structure inside thereof that is produced by ionizing and swelling the acid group of the core by the action of a volatile base.

2. The hollow particle according to claim 1, wherein the ratio by mass of the core to the shell (core/shell) falls within a range of from 1/99 to 50/50, and the ratio by mass of the interlayer to the outer layer in the shell (interlayer/outer layer) falls within a range of from 60/40 to 90/10.

3. The hollow particle according to claim 1, wherein the core containing an acid group is a copolymer and contains a repetitive unit of the following formula [1]: 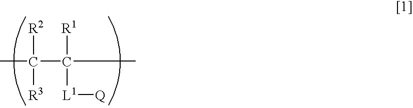
in which, R¹, R² and R³ each independently represent a hydrogen atom or a substituent; L¹ represents a group selected from the following linking groups, or a divalent linking group formed by combining two or more of the linking groups; Q represents a carboxyl group (—COOH), a sulfo group (—SO₃H), or a phosphoryl group (—OPO₃H);
(Linking Group)
single bond, —O—, —CO—, —NR⁴—, —S—, —SO₂—, —P(═O)(OR⁵)—, alkylene group, arylene group in which R⁴ represents a hydrogen atom, an alkyl group, a cycloalkyl group, an aryl group or an aralkyl group; and R⁵ represents an alkyl group, a cycloalkyl group, an aryl group or an aralkyl group.

4. The hollow particle according to claim 1, wherein the core containing an acid group is a copolymer with methacrylic acid or acrylic acid.

5. The hollow particle according to claim 1, wherein the interlayer is a copolymer of a monomer selected from aromatic vinyl compounds and (meth)acrylates.

6. A method for producing a hollow particle having a core/shell structure in which the core contains an acid group and is crosslinked, the surface of the core is covered with an interlayer of an acid group-free, crosslinked resin having a glass transition temperature (Tg) of from −60° C. to 80° C., and the surface of the interlayer is covered with an outer layer of an acid group-free, crosslinked resin having a glass transition temperature (Tg) of from 80 to 150° C.;
the method comprising ionizing the acid group of the core through contact with a volatile base and then swelling it under osmotic pressure to thereby form a hollow structure.

7. The method for producing a hollow particle according to claim 6, wherein the ratio by mass of the core to the shell (core/shell) falls within a range of from 1/99 to 50/50, and the ratio by mass of the interlayer to the outer layer in the shell (interlayer/outer layer) falls within a range of from 60/40 to 90/10.

8. The method for producing a hollow particle according to claim 6, wherein the core containing an acid group is a copolymer and contains a repetitive unit of the following formula [1]: 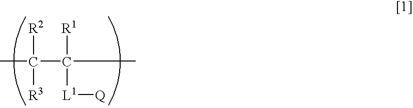
in which, R¹, R² and R³ each independently represent a hydrogen atom or a substituent; L¹ represents a group selected from the following linking groups, or a divalent linking group formed by combining two or more of the linking groups; Q represents a carboxyl group (—COOH), a sulfo group (—SO₃H), or a phosphoryl group (—OPO₃H);
(Linking Group)
single bond, —O—, —CO—, —NR⁴—, —S—, —SO₂—, —P(═O) (OR⁵)—, alkylene group, arylene group in which R⁴ represents a hydrogen atom, an alkyl group, a cycloalkyl group, an aryl group or an aralkyl group; and R⁵ represents an alkyl group, a cycloalkyl group, an aryl group or an aralkyl group.

9. The method for producing a hollow particle according to claim 6, wherein the core containing an acid group is a copolymer with methacrylic acid or acrylic acid.

10. The method for producing a hollow particle according to claim 6, wherein the interlayer is a copolymer of a monomer selected from aromatic vinyl compounds and (meth)acrylates.

11. The method for producing a hollow particle according to claim 6, wherein the particle is produced through seed emulsion polymerization.

12. The method for producing a hollow particle according to claim 6, which comprises contacting the particle having a structure of such that the surface of the core that contains an acid group and is crosslinked is covered with an interlayer of an acid group-free, crosslinked resin having a glass transition temperature (Tg) of from −60° C. to 80° C. and the surface of the interlayer is covered with an outer layer of an acid group-free, crosslinked resin having a glass transition temperature (Tg) of from 80 to 150° C., with a volatile base to thereby ionize the acid group of the core and swelling it under osmotic pressure to form a hollow structure.

13. A hollow particle produced by the method of claim 6.

14. A latex of hollow particles of claim 1.

15. A film containing hollow particles of claim 1.

16. A thermal transfer image-receiving sheet containing an interlayer and a receiving layer formed in order on a support, wherein the interlayer contains hollow particles of claim 1.
